(19) United States
(12) Patent Application Publication
(10) Pub. No.: US 2023/0309147 A1
(43) Pub. Date: Sep. 28, 2023

(54) NETWORK ASSISTED INITIAL ACCESS FOR HOLOGRAPHIC MIMO

(71) Applicant: QUALCOMM Incorporated, San Diego, CA (US)

(72) Inventors: Qiaoyu LI, Beijing (CN); Wei XI, Beijing (CN); Yu ZHANG, San Diego, CA (US); Hao XU, Beijing (CN)

(21) Appl. No.: 18/005,153

(22) PCT Filed: Aug. 26, 2021
(86) PCT No.: PCT/CN2021/114692

§ 371 Date: Jan. 11, 2023

(30) Foreign Application Priority Data
Sep. 24, 2020 (WO) PCT/CN2020/117390
Sep. 24, 2020 (WO) PCT/CN2020/117438

(51) Int. Cl. H04W 74/08; H04B 17/318; H04W 24/10

(52) U.S. Cl. CPC H04W 74/0833; H04B 17/328; H04W 24/10

(57) ABSTRACT

Certain aspects of the present disclosure provide techniques that may be executed by a new radio (NR) gNB for sending signaling to a user equipment (UE), which may indicate information that may enable the UE to measure synchronization signal blocks (SSBs) that each have an associated range and an associated direction, for performing an initial access procedure.

### CROSS-REFERENCE TO RELATED APPLICATIONS

This application claims benefit of and priority to PCT Application Nos. PCT/CN2020/117438, filed Sep. 24, 2020, and PCT/CN2020/117390, filed Sep. 24, 2020, both of which are hereby incorporated by reference in their entireties.

### BACKGROUND

### Field of the Disclosure

Aspects of the present disclosure relate to wireless communications, and more particularly, to techniques for initial access for holographic multiple-input multiple-output (MIMO).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd generation partnership project (3GPP) long term evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New Radio (NR) (e.g., 5^{th} generation (5G)) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on a downlink (DL) and on an uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved and efficient techniques for performing an initial access for holographic multiple-input multiple-output (MIMO).

Certain aspects of the subject matter described in this disclosure can be implemented in a method for wireless communication by a user equipment (UE). The method generally includes receiving from a first network entity that transmits synchronization signal block (SSBs) of a first type that each have an associated direction signaling indicating information enabling the UE to measure SSBs of a second type that each have an associated range and an associated direction, measuring SSBs of the first and second type based on the information, and reporting the SSB measurements.

Certain aspects of the subject matter described in this disclosure can be implemented in an apparatus for wireless communications by a UE. The apparatus generally includes at least one application processor and a memory configured to: receive from a first network entity that transmits SSBs of a first type that each have an associated direction signaling indicating information enabling the UE to measure SSBs of a second type that each have an associated range and an associated direction, measure SSBs of the first and second type based on the information, and report the SSB measurements.

Certain aspects of the subject matter described in this disclosure can be implemented in an apparatus for wireless communications by a UE. The apparatus generally includes means for receiving from a first network entity that transmits SSBs of a first type that each have an associated direction signaling indicating information enabling the UE to measure SSBs of a second type that each have an associated range and an associated direction, means for measuring SSBs of the first and second type based on the information, and means for reporting the SSB measurements.

Certain aspects of the subject matter described in this disclosure can be implemented in a computer readable medium storing computer executable code thereon for wireless communications by a UE. The computer readable medium generally includes code for receiving from a first network entity that transmits SSBs of a first type that each have an associated direction signaling indicating information enabling the UE to measure SSBs of a second type that each have an associated range and an associated direction, code for measuring SSBs of the first and second type based on the information, and code for reporting the SSB measurements.

Certain aspects of the subject matter described in this disclosure can be implemented in a method for wireless communication by a first network entity. The method generally includes transmitting to a UE signaling indicating information enabling the UE to measure SSBs of a second type that each have an associated range and an associated direction, transmitting the SSBs of a first type that each have an associated direction, and receiving from the UE SSB measurements of the first and second type based on the information.

Certain aspects of the subject matter described in this disclosure can be implemented in an apparatus for wireless communications by a first network entity. The apparatus generally includes at least one application processor and a memory configured to: transmit to a UE signaling indicating information enabling the UE to measure SSBs of a second type that each have an associated range and an associated direction, transmit the SSBs of a first type that each have an associated direction, and receive from the UE SSB measurements of the first and second type based on the information.

Certain aspects of the subject matter described in this disclosure can be implemented in an apparatus for wireless communications by a first network entity. The apparatus generally includes means for transmitting to a UE signaling indicating information enabling the UE to measure SSBs of a second type that each have an associated range and an associated direction, means for transmitting the SSBs of a first type that each have an associated direction, and means for receiving from the UE SSB measurements of the first and second type based on the information.

Certain aspects of the subject matter described in this disclosure can be implemented in a computer readable medium storing computer executable code thereon for wireless communications by a first network entity. The computer readable medium generally includes code for transmitting to a UE signaling indicating information enabling the UE to measure SSBs of a second type that each have an associated range and an associated direction, code for transmitting the SSBs of a first type that each have an associated direction, and code for receiving from the UE SSB measurements of the first and second type based on the information.

Certain aspects of the subject matter described in this disclosure can be implemented in a method for wireless communication by a UE. The method generally includes receiving, from a first network entity that transmits SSBs of a first type that each have an associated direction, information indicating the presence of SSBs of a second type that each have an associated range and an associated direction; and sending, to the first network entity, a report indicating a capability of the UE to support SSBs of the second type.

Certain aspects of the subject matter described in this disclosure can be implemented in an apparatus for wireless communications by a UE. The apparatus generally includes at least one application processor and a memory configured to: receive, from a first network entity that transmits SSBs of a first type that each have an associated direction, information indicating the presence of SSBs of a second type that each have an associated range and an associated direction; and send, to the first network entity, a report indicating a capability of the UE to support SSBs of the second type.

Certain aspects of the subject matter described in this disclosure can be implemented in an apparatus for wireless communications by a UE. The apparatus generally includes means for receiving, from a first network entity that transmits SSBs of a first type that each have an associated direction, information indicating the presence of SSBs of a second type that each have an associated range and an associated direction; and means for sending, to the first network entity, a report indicating a capability of the UE to support SSBs of the second type.

Certain aspects of the subject matter described in this disclosure can be implemented in a computer readable medium storing computer executable code thereon for wireless communications by a UE. The computer readable medium generally includes code for receiving, from a first network entity that transmits SSBs of a first type that each have an associated direction, information indicating the presence of SSBs of a second type that each have an associated range and an associated direction; and code for sending, to the first network entity, a report indicating a capability of the UE to support SSBs of the second type.

Certain aspects of the subject matter described in this disclosure can be implemented in a method for wireless communication by a first network entity. The method generally includes sending to a UE, SSBs of a first type that each have an associated direction, sending to the UE signaling indicating information about the presence of SSBs of a second type that each have an associated range and an associated direction; and receiving from the UE a report indicating a capability of the UE to support SSBs of the second type.

Certain aspects of the subject matter described in this disclosure can be implemented in an apparatus for wireless communications by a first network entity. The apparatus generally includes at least one application processor and a memory configured to: send to a UE, SSBs of a first type that each have an associated direction, send to the UE signaling indicating information about the presence of SSBs of a second type that each have an associated range and an associated direction; and receive from the UE a report indicating a capability of the UE to support SSBs of the second type.

Certain aspects of the subject matter described in this disclosure can be implemented in an apparatus for wireless communications by a first network entity. The apparatus generally includes means for sending to a UE, SSBs of a first type that each have an associated direction, means for sending to the UE signaling indicating information about the presence of SSBs of a second type that each have an associated range and an associated direction; and means for receiving from the UE a report indicating a capability of the UE to support SSBs of the second type.

Certain aspects of the subject matter described in this disclosure can be implemented in a computer readable medium storing computer executable code thereon for wireless communications by a first network entity. The computer readable medium generally includes code for sending to a UE, SSBs of a first type that each have an associated direction, code for sending to the UE signaling indicating information about the presence of SSBs of a second type that each have an associated range and an associated direction; and code for receiving from the UE a report indicating a capability of the UE to support SSBs of the second type.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, according to aspects of the present disclosure.

FIG. 2 is a block diagram conceptually illustrating a design of an example base station (BS) and a user equipment (UE), according to aspects of the present disclosure.

FIG. 3 is an example frame format for certain wireless communication systems (e.g., a new radio (NR)), according to aspects of the present disclosure.

FIG. 4 illustrates how different synchronization signal blocks (SSBs) may be sent using different beams.

FIG. 5 shows example transmission resource mapping.

FIGS. 6A and 6B illustrate examples of SSB patterns for different subcarrier spacings (SCSs).

FIG. 7 illustrates example beams.

FIG. 8 illustrates example holographic beamforming and NR beamforming.

FIG. 9 illustrates example antenna elements specification.

FIG. 10 illustrates example SSB structure.

FIGS. 11A and 11B illustrate examples of holographically beamformed three-dimensional SSBs (3D-SSBs) for a near field UE and conventionally beamformed 2D-SSBs for a far field UE.

FIG. 12 is a flow diagram illustrating example operations for wireless communication by a UE, according to aspects of the present disclosure.

FIG. 13 is a flow diagram illustrating example operations for wireless communication by a first network entity, according to aspects of the present disclosure.

FIG. 14 illustrates example signaling of holographic SSB information by NR-gNB, according to aspects of the present disclosure.

FIGS. 15-16 illustrate example operations by a UE to access a holographic gNB, according to aspects of the present disclosure.

FIG. 17 illustrates example on-demand holographic SSB transmission, a second network entity, and a UE, according to aspects of the present disclosure.

FIG. 18 is a flow diagram illustrating example operations for wireless communication by a UE, according to aspects of the present disclosure.

FIG. 19 is a flow diagram illustrating example operations for wireless communication by a first network entity, according to aspects of the present disclosure.

FIG. 20 illustrates example operations for transmitting 3D-SSB detection capability early report, according to aspects of the present disclosure.

FIG. 21 illustrates example operations for NR-gNB configuration/indication of 3D-SSBs, according to aspects of the present disclosure.

FIG. 22 illustrates a communications device that may include various components configured to perform operations for techniques disclosed herein, according to aspects of the present disclosure.

FIG. 23 illustrates a communications device that may include various components configured to perform operations for techniques disclosed herein, according to aspects of the present disclosure.

FIG. 24 illustrates a communications device that may include various components configured to perform operations for techniques disclosed herein, according to aspects of the present disclosure.

FIG. 25 illustrates a communications device that may include various components configured to perform operations for techniques disclosed herein, according to aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for initial access for holographic multiple-input multiple-output (MIMO).

In one example technique, a first network entity (e.g., a new radio (NR) gNB) may send signaling indicating information enabling a user equipment (UE) to measure three-dimensional synchronization signal blocks (3D-SSBs) that each have an associated range and an associated direction. The UE may measure the 3D-SSBs based on the information, and then report the SSB measurements. In some cases, the UE may perform an initial access procedure based on the 3D-SSBs.

In another example technique, a first network entity may send 2D-SSBs to a UE during an initial access procedure. The first network entity may also send information regarding a presence of 3D-SSBs, to the UE, via one or more channels associated with the 2D-SSBs, during the initial access procedure. A second network entity (e.g., a holographic gNB) may transmit the 3D-SSBs. In response to receiving the information, the UE may send a report to the first network entity indicating a capability of the UE to detect and decode different types of the 3D-SSBs. The first network entity may select a configuration of the 3D-SSBs based on the report. The first network entity may send the selected configuration of the 3D-SSBs to the UE. The UE may use the received configuration of the 3D-SSBs to monitor the 3D-SSBs. The UE may use the monitored 3D-SSBs for the initial access procedure.

Exchanging capability information in this manner may help avoid the significant resource overhead associated with transmitting 3D-SSBs. In other words, in some cases, the network may only send 3D-SSBs after receiving confirmation that the UE has the capability to support them.

The following description provides examples of holographic MIMO based initial access in wireless communication systems. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G new radio (NR)) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may coexist in the same subframe.

The electromagnetic spectrum is often subdivided, based on frequency/wavelength, into various classes, bands, channels, etc. In 5G NR two initial operating bands have been identified as frequency range designations FR1 (410 MHz -7.125 GHz) and FR2 (24.25 GHz - 52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. Multiple-input multiple-output (MIMO) transmissions with precoding may also be supported. MIMO configurations in a downlink may support up to 8 transmit antennas with multi-layer downlink transmissions up to 8 streams and up to 2 streams per UE. Multi-layer transmissions with up to 2 streams per UE may be supported. Aggregation of multiple cells may be supported with up to 8 serving cells.

### Example Wireless Communication System

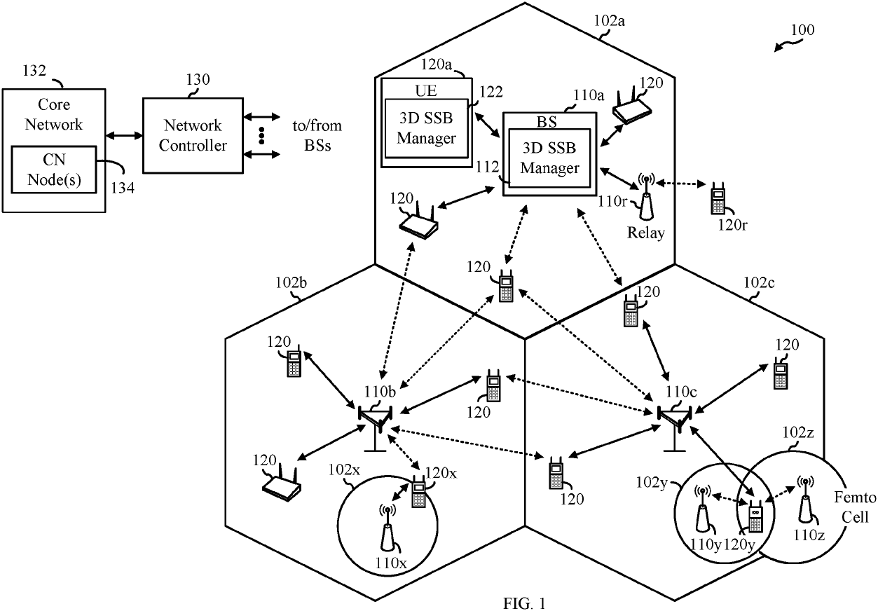

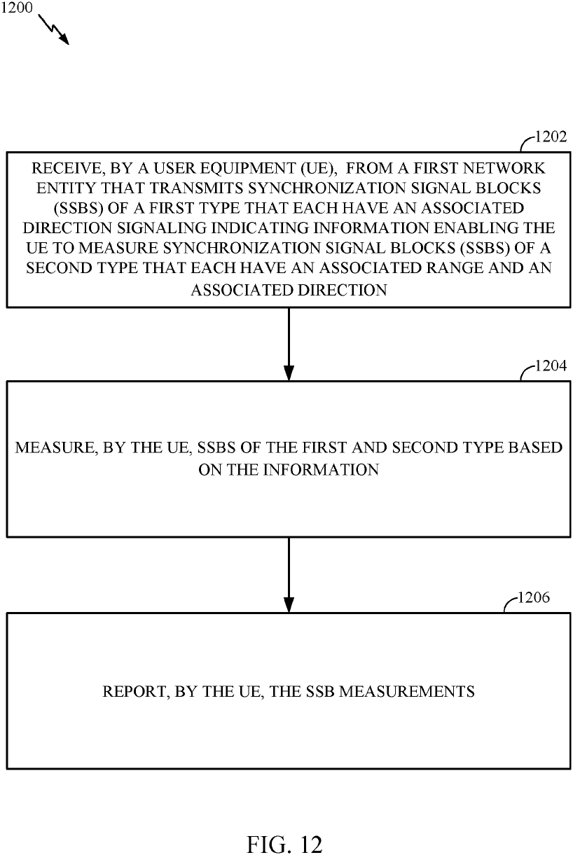

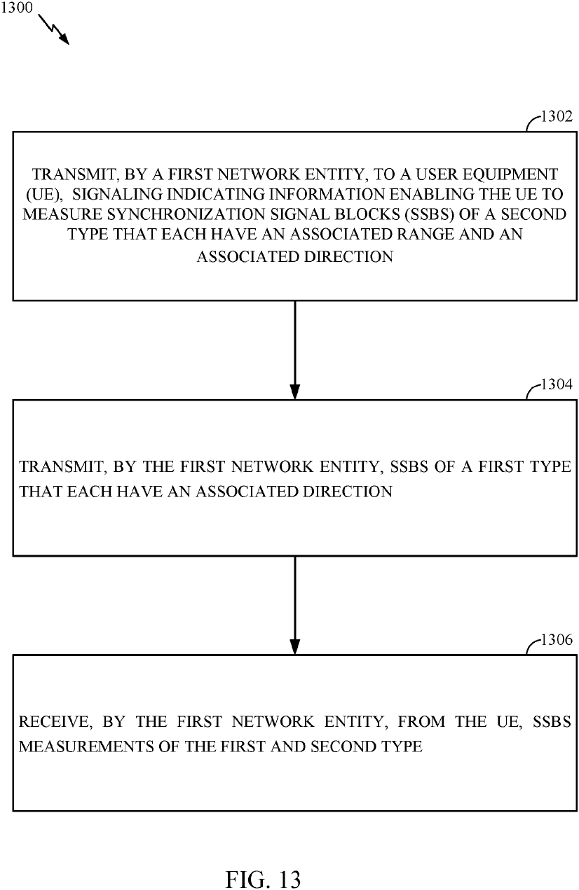

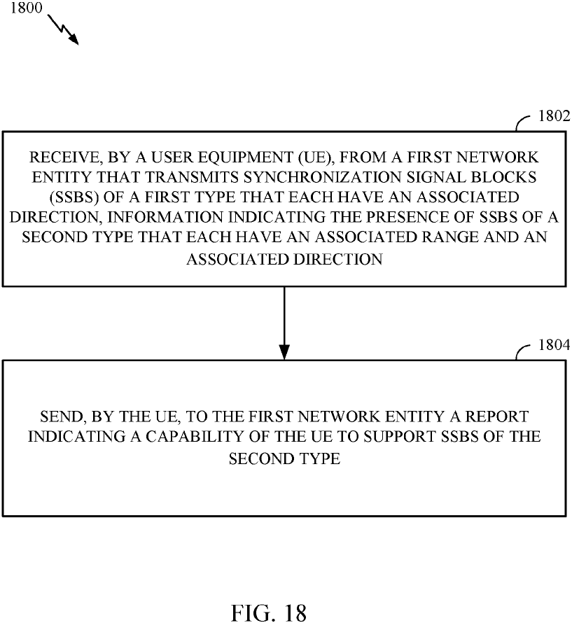

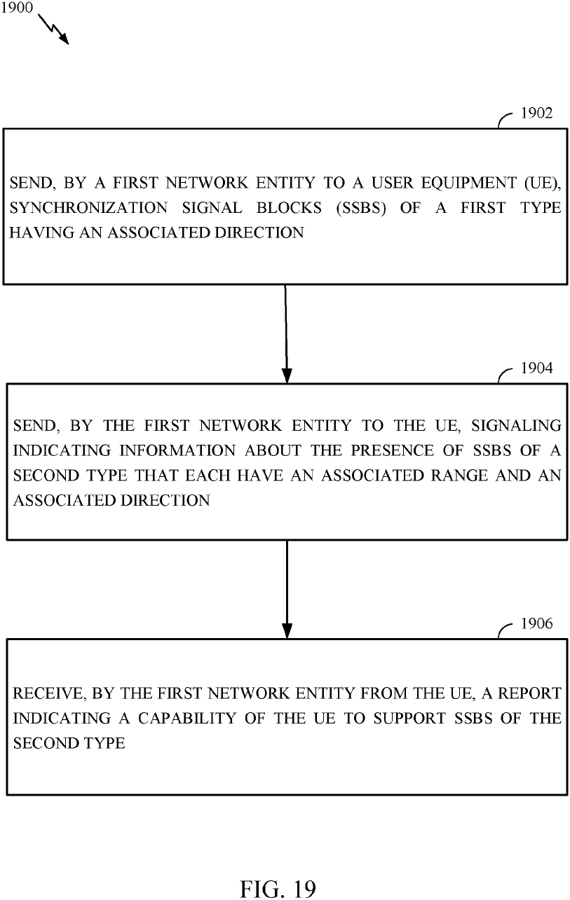

FIG. 1 illustrates an example wireless communication network 100, in which aspects of the present disclosure may be practiced. For example, according to certain aspects, the wireless communication network 100 may include base stations (BSs) 110 and/or user equipments (UEs) 120 configured for performing initial access for holographic multiple-input multiple-output (MIMO). As shown in FIG. 1, a UE 120a includes a 3D synchronization signal block (SSB) manager 122 configured to perform operations 1200 of FIG. 12 and operations 1800 of FIG. 18. A BS 110a includes a 3D SSB manager 112 configured to perform operations 1300 of FIG. 13 and operations 1900 of FIG. 19.

The wireless communication network 100 may be a new radio (NR) system (e.g., a 5^{th} generation (5G) NR network). As shown in FIG. 1, the wireless communication network 100 is in communication with a core network 132. The core network may in communication with BSs 110a-z (each also individually referred to herein as a BS 110 or collectively as BSs 110) and/or UEs 120a-y (each also individually referred to herein as a UE 120 or collectively as UEs 120) in the wireless communication network 100 via one or more interfaces.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

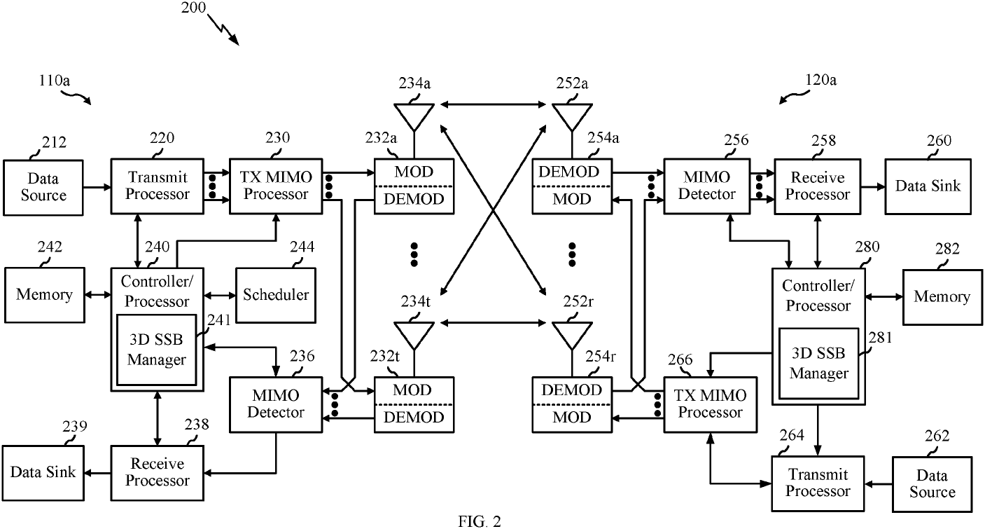

FIG. 2 illustrates example components of a BS 110a and a UE 120a (e.g., in the wireless communication network 100 of FIG. 1).

At the BS 110a, a transmit processor 220 may receive data from a data source 212 and control information from a controller/processor 240. The control information may be for a physical broadcast channel (PBCH), a physical control format indicator channel (PCFICH), a physical hybrid ARQ indicator channel (PHICH), a physical downlink control channel (PDCCH), a group common PDCCH (GC PDCCH), etc. The data may be for a physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The transmit processor 220 may process (e.g., encode and symbol map) the data and control information to obtain data symbols and control symbols, respectively. The transmit processor 220 may also generate reference symbols, such as for a primary synchronization signal (PSS), a secondary synchronization signal (SSS), and a channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a-232t. Each MOD 232 may process a respective output symbol stream (e.g., for OFDM, etc.) to obtain an output sample stream. Each MOD 232 may further process (e.g., convert to analog, amplify, filter, and upconvert) the output sample stream to obtain a downlink signal. The downlink signals from the MODs 232a-232t may be transmitted via antennas 234a-234t, respectively.

At the UE 120, antennas 252a-252r may receive the downlink signals from the BS 110 and may provide received signals to demodulators (DEMODs) in transceivers 254a-254r, respectively. Each DEMOD in the transceiver 254 may condition (e.g., filter, amplify, downconvert, and digitize) a respective received signal to obtain input samples. Each DEMOD in the transceiver may further process the input samples (e.g., for OFDM, etc.) to obtain received symbols. A MIMO detector 256 may obtain received symbols from all the DEMODs in the transceivers 254a-254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at the UE 120, a transmit processor 264 may receive and process data (e.g., for a physical uplink shared channel (PUSCH)) from a data source 262 and control information (e.g., for a physical uplink control channel (PUCCH) from the controller/processor 280. The transmit processor 264 may also generate reference symbols for a reference signal (e.g., for a sounding reference signal (SRS)). The symbols from the transmit processor 264 may be precoded by a TX MIMO processor 266 if applicable, further processed by the DEMODs in transceivers 254a-254r (e.g., for SC-FDM, etc.), and transmitted to the BS 110. At the BS 110, the uplink signals from the UE 120 may be received by the antennas 234, processed by the MODs 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

Memories 242 and 282 may store data and program codes for the BS 110 and the UE 120, respectively. A scheduler 244 may schedule the UEs for 120 data transmission on a downlink and/or an uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a includes a 3D SSB module 241 that may be configured to perform the operations illustrated in FIG. 13 and FIG. 19, as well as other operations disclosed herein, in accordance with aspects of the present disclosure. As shown in FIG. 2, the controller/processor 280 of the UE 120a includes a 3D-SSB module 281 that may be configured to perform the operations illustrated in FIG. 12 and FIG. 18, as well as other operations disclosed herein for, in accordance with aspects of the present disclosure. Although shown at the controller/processor, other components of the UE 120a and the BS 110a may be used performing the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

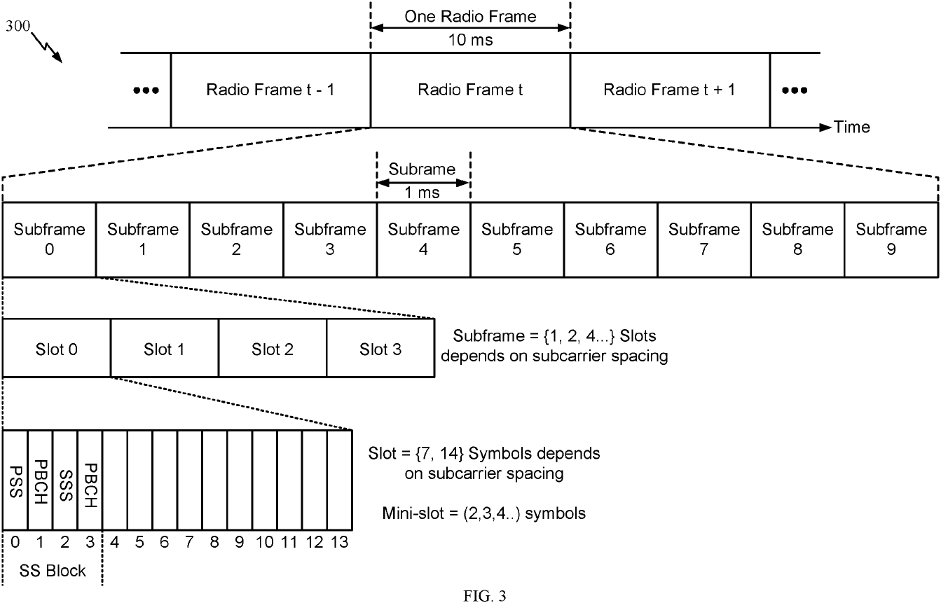

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, ... slots) depending on the SCS. Each slot may include a variable number of symbol periods (e.g., 7 or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block (SSB) is transmitted. The SS block includes a PSS, a SSS, and a two symbol PBCH. The SS block can be transmitted in a fixed slot location, such as the symbols 0-3 as shown in FIG. 3. The PSS and SSS may be used by UEs for cell search and acquisition. The PSS may provide half-frame timing, and the SS may provide the CP length and frame timing. The PSS and SSS may provide the cell identity. The PBCH carries some basic system information, such as downlink system bandwidth, timing information within radio frame, SS burst set periodicity, system frame number, etc.

Further system information such as, remaining minimum system information (RMSI), system information blocks (SIBs), other system information (OSI) can be transmitted on a physical downlink shared channel (PDSCH) in certain subframes.

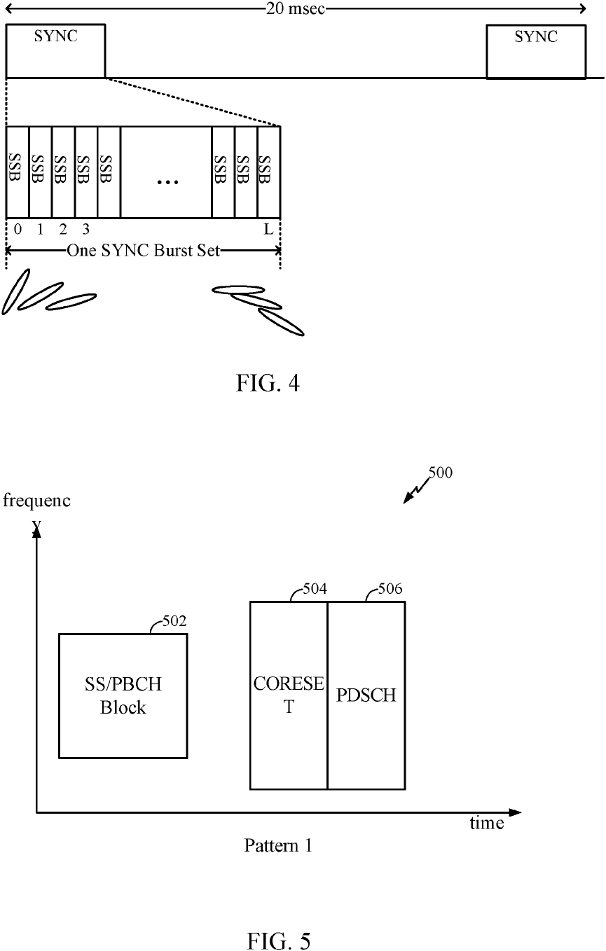

As shown in FIG. 4, the SS blocks may be organized into SS burst sets to support beam sweeping. As shown, each SSB within a burst set may be transmitted using a different beam, which may help a UE quickly acquire both transmit (Tx) and receive (Rx) beams (particular for mmW applications). A physical cell identity (PCI) may still decoded from the PSS and SSS of the SSB.

Certain deployment scenarios may include one or both NR deployment options. Some may be configured for non-standalone (NSA) and/or standalone (SA) option. A standalone cell may need to broadcast both SSB and remaining minimum system information (RMSI), for example, with SIB1 and SIB2. A non-standalone cell may only need to broadcast SSB, without broadcasting RMSI. In a single carrier in NR, multiple SSBs may be sent in different frequencies, and may include the different types of SSB.

### Control Resource Sets (CORESETs)

A control resource set (CORESET) for an orthogonal frequency division multiple access (OFDMA) system (e.g., a communications system transmitting physical downlink control channel (PDCCH) using OFDMA waveforms) may comprise one or more control resource (e.g., time and frequency resources) sets, configured for conveying PDCCH, within a system bandwidth (e.g., a specific area on new radio (NR) downlink resource grid) and a set of parameters used to carry PDCCH/downlink control information (DCI). For example, a CORESET may by similar in area to a long term evolution (LTE) PDCCH area (e.g., the first 1,2,3,4 OFDM symbols in a subframe).

Within each CORESET, one or more search spaces (e.g., common search space (CSS), UE-specific search space (USS), etc.) may be defined for a given UE. Search spaces are generally areas or portions where a communication device (e.g., a UE) may look for control information.

According to aspects of the present disclosure, a CORESET is a set of time and frequency domain resources, defined in units of resource element groups (REGs). Each REG may comprise a fixed number (e.g., twelve) tones/subcarriers in one symbol period (e.g., a symbol period of a slot), where one tone in one symbol period is referred to as a resource element (RE). A fixed number of REGs, such as six, may be included in a control channel element (CCE). Sets of CCEs may be used to transmit new radio PDCCHs (NR-PDCCHs), with different numbers of CCEs in the sets used to transmit NR-PDCCHs using differing aggregation levels. Multiple sets of CCEs may be defined as search spaces for UEs, and thus a NodeB or other base station may transmit an NR-PDCCH to a UE by transmitting the NR-PDCCH in a set of CCEs that is defined as a decoding candidate within a search space for the UE. The UE may receive the NR-PDCCH by searching in search spaces for the UE and decoding the NR-PDCCH transmitted by the NodeB.

As noted above, different aggregation levels may be used to transmit sets of CCEs. Aggregation levels may be generally defined as the number of CCEs that consist of a PDCCH candidate and may include aggregation levels 1, 2, 4, 8, and 18, which may be configured by a radio resource control (RRC) configuration of a search space set (SS-set). A CORESET may be linked with the SS-set within the RRC configuration. For each aggregation level, the number of PDCCH candidates may be RRC configurable.

Operating characteristics of a NodeB or other base station in an NR communications system may be dependent on a frequency range (FR) in which the system operates. A frequency range may comprise one or more operating bands (e.g., “n1” band, “n2” band, “n7” band, and “n41” band), and a communications system (e.g., one or more NodeBs and UEs) may operate in one or more operating bands. Frequency ranges and operating bands are described in more detail in “Base Station (BS) radio transmission and reception” TS38.104 (Release 15), which is available from the 3GPP website.

As described above, a CORESET is a set of time and frequency domain resources. The CORESET can be configured for conveying PDCCH within system bandwidth. A UE may determine a CORESET and monitors the CORESET for control channels. During initial access, a UE may identify an initial CORESET (CORESET #0) configuration from a field (e.g., pdcchConfigSIB1) in a maser information block (MIB). This initial CORESET may then be used to configure the UE (e.g., with other CORESETs and/or bandwidth parts via dedicated (UE-specific) signaling. When the UE detects a control channel in the CORESET, the UE attempts to decode the control channel and communicates with the transmitting BS (e.g., the transmitting cell) according to the control data provided in the control channel (e.g., transmitted via the CORESET).

In some cases, CORESET #0 may include different numbers of resource blocks (RBs). For example, in some cases, CORESET #0 may include one of 24, 48, or 96 RBs. For other CORESETSs, a 45-bit bitmap may be used to configure available RB-groups, where each bit in the bitmap is with respect to 6-RBs within a bandwidth part (BWP) and a most significant bit corresponds to the first RB-group in the BWP.

According to aspects of the present disclosure, when a UE is connected to a cell (or BS), the UE may receive a master information block (MIB). The MIB can be in a synchronization signal and physical broadcast channel (SS/PBCH) block (e.g., in the PBCH of the SS/PBCH block) on a synchronization raster (sync raster). In some scenarios, the sync raster may correspond to an SSB. From the frequency of the sync raster, the UE may determine an operating band of the cell. Based on a cell’s operation band, the UE may determine a minimum channel bandwidth and a subcarrier spacing (SCS) of the channel. The UE may then determine an index from the MIB (e.g., four bits in the MIB, conveying an index in a range 0-15).

Given this index, the UE may look up or locate a CORESET configuration (this initial CORESET configured via the MIB is generally referred to as CORESET #0). This may be accomplished from one or more tables of CORESET configurations. These configurations (including single table scenarios) may include various subsets of indices indicating valid CORESET configurations for various combinations of minimum channel bandwidth and subcarrier spacing (SCS). In some arrangements, each combination of minimum channel bandwidth and SCS may be mapped to a subset of indices in the table.

Alternatively or additionally, the UE may select a search space CORESET configuration table from several tables of CORESET configurations. These configurations can be based on a minimum channel bandwidth and SCS. The UE may then look up a CORESET configuration (e.g., a Type0-PDCCH search space CORESET configuration) from the selected table, based on the index. After determining the CORESET configuration (e.g., from the single table or the selected table), the UE may then determine the CORESET to be monitored (as mentioned above) based on the location (in time and frequency) of the SS/PBCH block and the CORESET configuration.

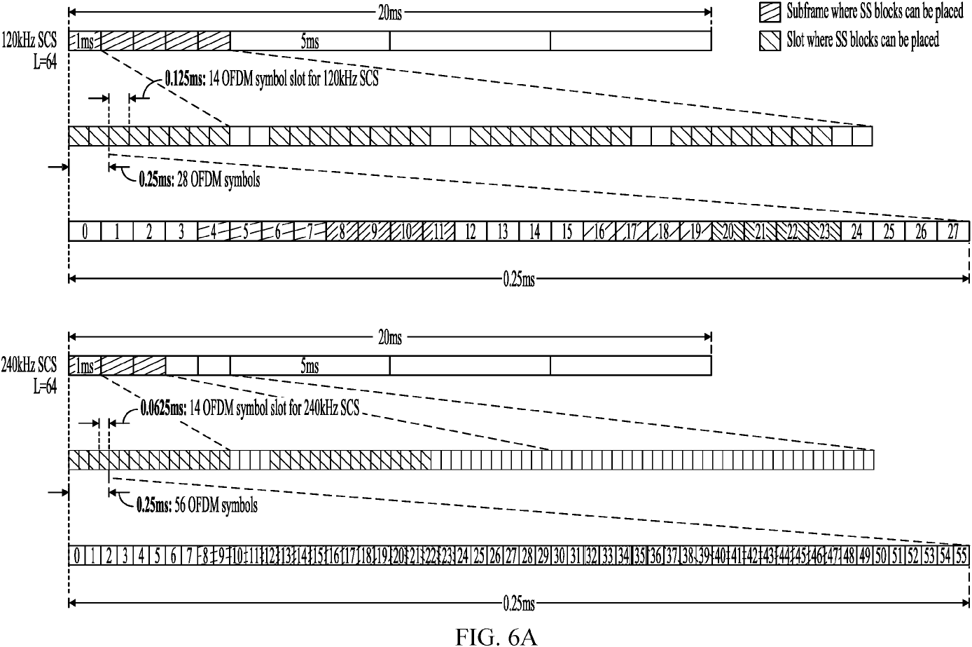

FIG. 5 shows example transmission resource mapping 500, according to aspects of the present disclosure. In the transmission resource mapping 500, a BS (e.g., BS 110a, shown in FIG. 1) transmits an SS/PBCH block 502. The SS/PBCH block includes a MIB conveying an index to a table that relates the time and frequency resources of the CORESET 504 to the time and frequency resources of the SS/PBCH block.

The BS may also transmit control signaling. In some scenarios, the BS may also transmit a PDCCH to a UE (e.g., UE 120, shown in FIG. 1) in the (time/frequency resources of the) CORESET. The PDCCH may schedule a PDSCH 506. The BS then transmits the PDSCH to the UE. The UE may receive the MIB in the SS/PBCH block, determine the index, look up a CORESET configuration based on the index, and determine the CORESET from the CORESET configuration and the SS/PBCH block. The UE may then monitor the CORESET, decode the PDCCH in the CORESET, and receive the PDSCH that was allocated by the PDCCH.

Different CORESET configurations may have different parameters that define a corresponding CORESET. For example, each configuration may indicate a number of resource blocks (e.g., 24, 48, or 96), a number of symbols (e.g., 1-3), as well as an offset (e.g., 0-38 RBs) that indicates a location in frequency.

Further, REG bundles may be used to convey CORESETs. REGs in an REG bundle may be contiguous in a frequency and/or a time domain. In certain cases, the time domain may be prioritized before the frequency domain. REG bundle sizes may include: 2, 3, or 6 for interleaved mapping and 6 for non-interleaved mapping.

As noted above, sets of CCEs may be used to transmit new radio PDCCHs (NR-PDCCHs), with different numbers of CCEs in the sets used to transmit NR-PDCCHs using differing aggregation levels.

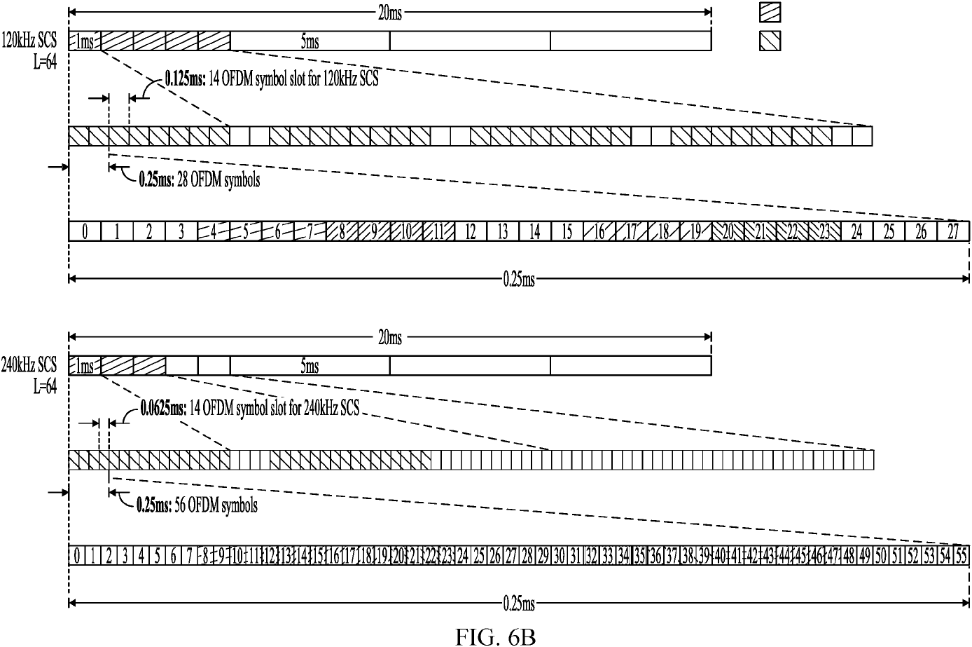

FIGS. 6A and 6B illustrate SS burst set locations within 5 ms half-frame, for SS with 15 kHz and 30 kHz subcarrier spacing (SCS). A maximum number of SSB index values L values are shown for each SCS. FIGS. 6A and 6B also show how there are 2 (band specific) mapping options for 30 kHz SCS. For example, in NR Rel-15/16, 64 SSBs may be supported in 5 ms, in every 20 ms.

### Example Holographic Beamforming

A wireless communication system includes one or more base stations (BSs) and one or more user equipments (UEs). The BSs or the UEs are equipped with multiple antennas, which are used to employ techniques such as new radio (NR) multiple-input multiple-output (MIMO) communications and/or beamforming.

Beamforming refers to a technique that may be used at a transmitting device (e.g., a BS) or a receiving device (e.g., a UE) to shape or steer an antenna beam (e.g., a transmit beam or receive beam) along a spatial path between the BS and the UE. Beamforming may always point towards a direction of the receiving device.

A beamformed transmission points in a direction. In one example, the direction may be depicted by azimuth angle of arrival (AoA) and azimuth angle of departure (AoD). In another example, the direction may be depicted by zenith angle of arrival (ZoA) and zenith angle of departure (ZoD).

The NR MIMO communications may employ multipath signal propagation by transmitting or receiving multiple signals via different spatial layers. The BS may transmit the multiple signals via different antennas. Similarly, the UE may receive the multiple signals via different antennas. NR MIMO communication techniques may include a single-user MIMO (SU-MIMO) where multiple spatial layers are transmitted to a same UE, and multiple-user MIMO (MU-MIMO) where multiple spatial layers are transmitted to multiple UEs.

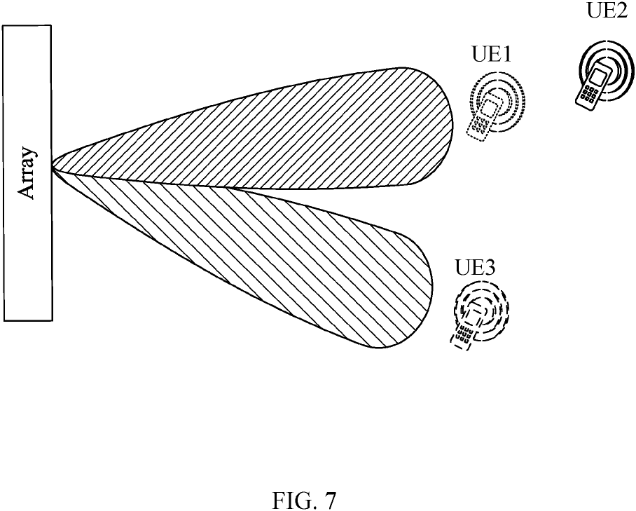

FIG. 7 illustrates an example of beamforming via NR MIMO depicting two beams used to reach 3 UEs (UE1, UE2, and UE3). Although NR MIMO communication operation offers significant increases in data throughput and link range without additional bandwidth or increased transmit power, a NR MIMO system may have some limitations. For instance, when there are multiple UEs present in a same direction but at different distances, such as UE1 and UE2, the NR MIMO system may be unable to distinguish between these UEs.

Also, two or more UEs with same or substantially similar azimuth and zenith may not be able to be paired for the MU-MIMO co-transmission. Accordingly, this may limit MU pairing opportunity and reduce MU diversity gain, resulting in lower order MU MIMO and lower spectral inefficiency.

Holographic MIMO refers to a system that utilizes an integration of a large number of antenna elements into a limited surface area (e.g., on the side of a building). Holographic MIMO may further enable a transmitter with such an antenna array to discriminate the distance away from itself (and receiving UEs). Also, Holographic MIMO may have some advantages over the NR MIMO. For instance, Holographic MIMO may allow pairing of multiple UEs in a same direction for the MU-MIMO.

Holographic beam forming (HBF) uses passive electronically steered antennas that use no active amplification internally. Using HBF, beamforming is accomplished using a hologram, as opposed to how a traditional phased array operates. HBF may have great advantage to serve UEs that are within a certain range from the antenna array, referred to as near field.

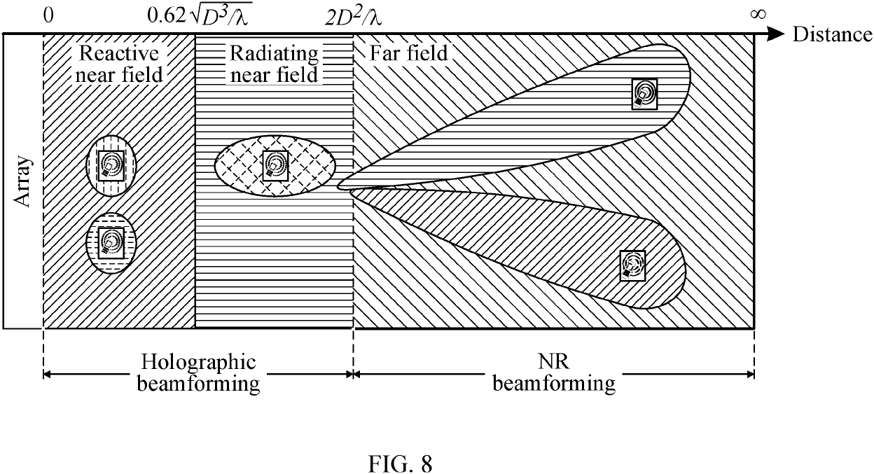

As illustrated in FIG. 8, HBF transmission characteristics in a near-field may change from reactive to radiating. In the near-field, beam focusing is possible and coding mechanisms in MIMO may be able to exploit this situation resulting in significant spectral efficiencies.

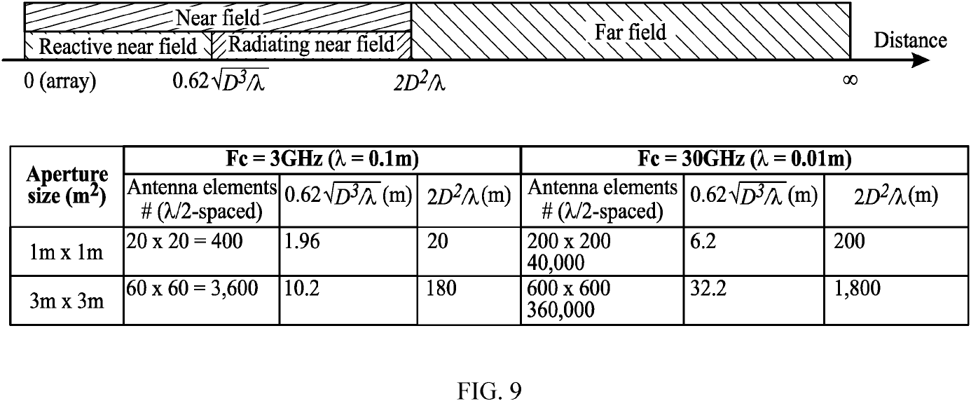

As illustrated in FIG. 9, near field coverage may be extended, for example, by increase the aperture size (D) and/or reducing the wavelength (λ), thereby increasing the carrier frequency (fc). As will be discussed herein, in some cases, a conventional transmitter (e.g., 5G gNB) may be used to communicate with UEs outside the near-field (the far field).

As noted above, holographic MIMO antenna arrays may provide a three-dimensional (3D) coverage. This may be used to generate more beam candidates in relation to 2D coverage provided by NR MIMO, potentially significantly more than the 64 SSBs supported in NR Rel. 15/16 (in a 5 ms half-frame, in every 20 ms).

Aspects of the present disclosure may help take advantage of holographic MIMO arrays, by providing techniques to support 3D-SSB based initial access procedures. The techniques may help address various challenges that may be posed with 3D-SSB based initial access, such as accommodating more (3D) SSB candidates (than conventional SSB candidates).

The techniques may also allow a UE to distinguish 3D-SSBs (which differ in direction and range) from conventional SSBs (which differ in direction only). As will described herein, the 3D-SSBs may be transmitted (and identified) using frequency division multiplexing (FDM), time division multiplexing (TDM), and/or spatial division multiplexing (SDM).

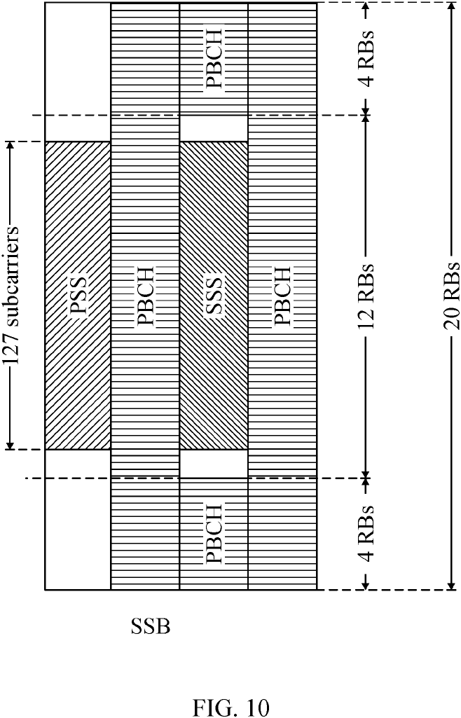

FIG. 10 illustrates an example SSB format. In some cases, SSB format and content may help identify an SSB as a 3D-SSB. For example, in some cases primary synchronization signal (PSS) and secondary synchronization signal (SSS) location may be swapped to identify an SSB as a 3D-SSB. As another example, certain sequences may be reserved for PSS and/or SSS in order to identify an SSB as a 3D-SSB. In some cases, a 3D-SSB may not have cell defining information, such as physical broadcast channel (PBCH) information.

### Example NR-gNB Assisted Initial Access

As noted above, holographic MIMO antenna arrays are used to transmit 3D synchronization signal blocks (3D-SSBs), which may differ from each other in direction and range. In contrast, conventional new radio (NR) MIMO antenna arrays are used to transmit 2D-SSBs, which may differ from each other in direction only, to provide this 2D coverage.

The holographic MIMO antenna arrays and the NR MIMO antenna arrays, at a same time, may transmit their respective SSBs within a certain field, for an initial access procedure. A user equipment (UE), which may be located closer to the holographic MIMO antenna arrays than the NR MIMO antenna arrays, may simultaneously receive both types of SSBs (the 3D-SSBs and the 2D-SSBs). In such a situation, the UE may not be able to distinguish between both types of SSBs.

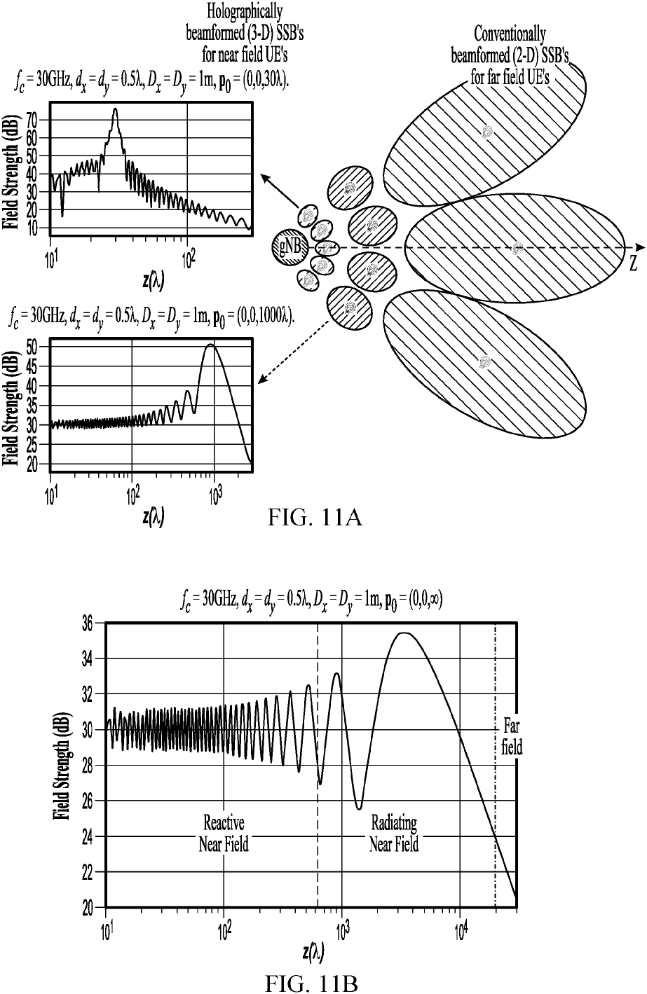

The UE may not be able to specifically determine that whether a received SSB, which may include a higher reference signal received power (RSRP) is a far-field 2D-SSB (transmitted by the NR MIMO antenna arrays) or a near-field 3D-SSB (transmitted by the holographic MIMO antenna arrays). This is because, although the UE may be located closer to the holographic MIMO antenna arrays than the NR MIMO antenna arrays, it is possible that the RSRP of the far-field 2D-SSB is higher than the RSRP of the near-field 3D-SSB, due to field strength variations associated with the RSRP of the near-field 3D-SSB (as illustrated in FIG. 11A and FIG. 11B).

As noted above, although the near-field 3D-SSB may have a lower RSRP in comparison to the RSRP of the far-field 2D-SSB, it is still possible to achieve a higher throughput with a holographic gNB (having the holographic MIMO antenna arrays sending the 3D-SSBs) in comparison to a NR-gNB (having the NR MIMO antenna arrays sending the 2D- SSBs). For instance, one or more beam steering techniques may be executed to achieve this higher throughput.

The UE may want use the 3D-SSB for an initial access procedure for access to a network entity (base station) with a holographic MIMO array. Therefore it may be useful for the UE to distinguish between 2D-SSBs and 3D-SSBs.

In some cases, for this purpose, the UE may set up a radio resource control (RRC) based connection with the NR-gNB. Using this RRC connection, the NR-gNB may configure the UE with channel state information (CSI) measurements to determine a better holographic beam. However, such an approach is sub-optimal because of multiple factors. For instance, as the UE may be located quite far away from the NR-gNB, the RRC connection between the UE and the NR-gNB is not efficient and reliable. In addition, these CSI measurements may not be appropriate, and may cause additional overhead during an operation.

Aspects of the present disclosure may help take advantage of holographic MIMO arrays, by providing techniques to support initial access procedures assisted by a network entity (e.g., an NR-gNB). The techniques may allow a UE to efficiently distinguish 3D-SSBs (which differ in direction and range) from conventional 2D-SSBs (which differ in direction only).

The information provided by the NR-gNB to the UE may indicate a SSB format, such as the format described above with reference to FIG. 10. The format and content may help the UE to identify an SSB as a 3D-SSB. For example, in some cases primary synchronization sequence (PSS) and secondary synchronization sequence (SSS) location may be swapped to identify the SSB as the 3D-SSB. As another example, certain sequences may be reserved for the PSS and/or the SSS in order to identify the SSB as the 3D-SSB. In some cases, the 3D-SSB may not have cell defining information, such as physical broadcast channel (PBCH) information.

The techniques also provide UE behaviors to identify/report preferred 3D-SSB candidates and to identify random access channel (RACH) occasions (ROs) associated with a particular SSB.

FIG. 12 is a flow diagram illustrating example operations 1200 for wireless communication by a UE. For example, operations 1200 may be performed by a UE (e.g., such as the UE 120a in FIG. 1 or FIG. 2) to measure 3D-SSBs based on information received from a first network entity (for example, NR-gNB), in accordance with aspects of the present disclosure. The operations 1200 may be implemented as software components that are executed and run on one or more processors (e.g., the controller/processor 280 of FIG. 2). Further, the transmission and reception of signals by the UE in operations 1200 may be enabled, for example, by one or more antennas (e.g., the antennas 252 of FIG. 2). In certain aspects, the transmission and/or reception of signals by the UE may be implemented via a bus interface of one or more processors (e.g., the controller/processor 280) obtaining and/or outputting signals.

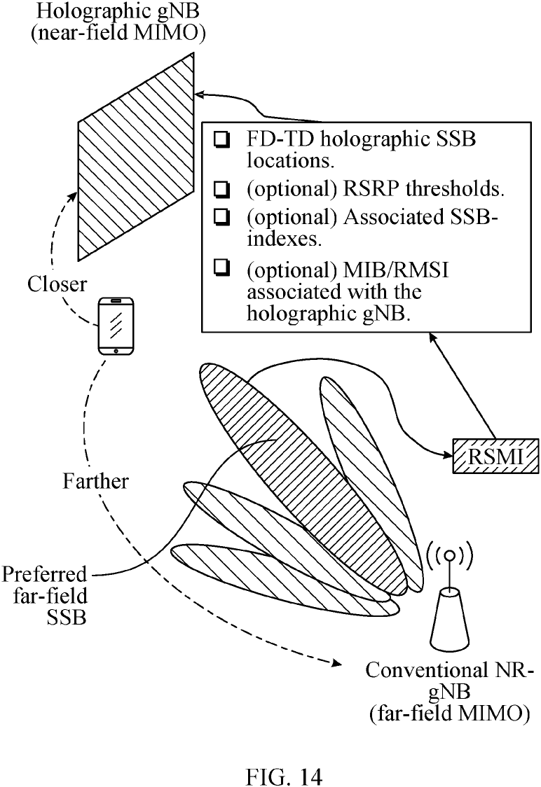

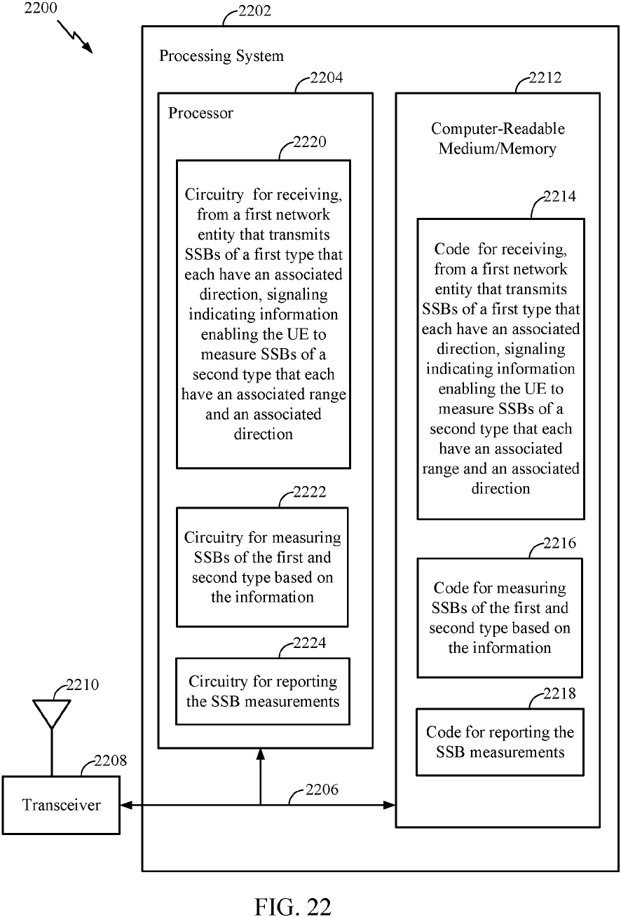

Operations 1200 begin, at 1202, by receiving from the first network entity that transmits SSBs of a first type that each have an associated direction, signaling indicating information enabling the UE to measure SSBs of a second type that each have an associated range and an associated direction. For example, the UE may receive the information using the antenna(s) and receiver/transceiver components of the UE 120a shown in FIG. 2 and/or of the apparatus shown in FIG. 22. In some cases, the information may be received during an initial access procedure. Various mechanisms (e.g., described below with reference to FIGS. 14-17) may be used to signal the information to the UE.

At 1204, the UE measures the SSBs of the first and second type based on the information. For example, the UE may measure the SSBs using a processor of the UE 120a shown in FIG. 2 and/or of the apparatus shown in FIG. 22. In some cases, the UE may measure the SSBs as part of a cell search procedure and/or a mobility procedure.

At 1206, the UE reports the SSB measurements. For example, the UE may transmit a report with the SSB measurements using the antenna(s) and transmitter/transceiver components of the UE 120a shown in FIG. 2 and/or of the apparatus shown in FIG. 22. In some cases, the report may be sent as part of a mobility procedure.

FIG. 13 is a flow diagram illustrating example operations 1300 for wireless communication by a first network entity that may be considered complementary to operations 1200 of FIG. 12. For example, operations 1300 may be performed, for example, by a first network entity (e.g., such as the BS 110a of FIG. 1 or FIG. 2). The operations 1300 may be implemented as software components that are executed and run on one or more processors (e.g., the controller/processor 240 of FIG. 2). Further, the transmission and reception of signals by the first network entity in operations 1300 may be enabled, for example, by one or more antennas (e.g., the antennas 234 of FIG. 2). In certain aspects, the transmission and/or reception of signals by the first network entity may be implemented via a bus interface of one or more processors (e.g., the controller/processor 240) obtaining and/or outputting signals.

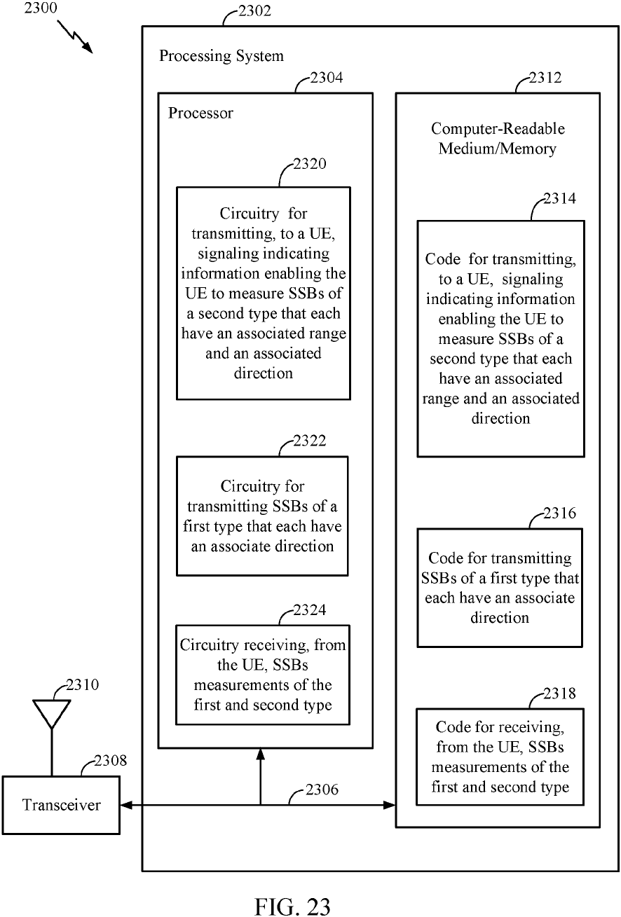

Operations 1300 begin, at 1302, by transmitting to the UE signaling indicating the information enabling the UE to measure SSBs of a second type that each have an associated range and an associated direction. For example, the first network entity may transmit the signaling using antenna(s) and transmitter/transceiver components of the BS 110a shown in FIG. 2 and/or of the apparatus shown in FIG. 23. In some cases, the information may be sent during an initial access procedure.

At 1304, the first network entity transmits SSBs of a first type that each have an associated direction. For example, the first network entity may transmit the SSBs of the first type using the antenna(s) and the transmitter/transceiver components of the BS 110a shown in FIG. 2 and/or of the apparatus shown in FIG. 23. In some cases, the information may be sent during an initial access procedure.

At 1306, the first network entity receives from the UE, SSB measurements of the first and second type. For example, the first network entity may receive the SSB measurements using the antenna(s) and receiver/transceiver components of the BS 110a shown in FIG. 2 and/or of the apparatus shown in FIG. 23. In some cases, the SSB measurements may be received during an initial access or mobility procedure.

The operations shown in FIGS. 12 and 13 may be understood with reference to FIGS. 14-17.

As illustrated in FIG. 14, a first network entity (for example, a NR-gNB) may communicate with a UE. The NR-gNB may transmit one or more SSBs of a first type (for example, 2D-SSBs). The NR-gNB may be located at a first distance from the UE. Also, a second network entity (for example, a holographic gNB) may communicate with the UE. The holographic gNB may transmit one or more SSBs of a second type (for example, 3D-SSBs). The holographic gNB may be located at a second distance from the UE. The first distance may be more than the second distance.

During an initial access procedure, the NR-gNB may send signaling to the UE. The signaling may indicate information to the UE. In some cases, the NR-gNB may convey the information to the UE using one or more channels.

In one non-limiting example, the NR-gNB may send a master information block (MIB) to the UE. The MIB may be associated with the 2D-SSBs transmitted by the NR-gNB. The NR-gNB may convey the information to the UE via the MIB. The MIB may also contain other data such as system bandwidth information, etc. The MIB may also indicate indexes for the 3D-SSBs, such as particular PSS/SSS sequences or DMRS sequence of PBCH. The UE may decode the MIB to receive one or more system information blocks (SIBs). The UE may decode the SIBs to obtain the information.

In another non-limiting example, the NR-gNB may send remaining minimum system information (RMSI) to the UE. The RMSI may be associated with the 2D-SSBs transmitted by the NR-gNB. The NR-gNB may send the information to the UE via the RMSI. The RMSI may also indicate the indexes for the 3D-SSBs, such as particular PSS/SSS sequences or DMRS sequence of PBCH. The UE may decode the RMSI to obtain the information.

In certain aspects, the information may correspond to 3D-SSBs identification information (i.e., the information that may assist the UE to determine that an SSB is a 3D-SSB).

In certain aspects, as the 3D-SSBs may be transmitted by the holographic gNB using frequency division multiplexing (FDM), time division multiplexing (TDM), and/or spatial division multiplexing (SDM), the information may include one or more TD locations and/or one or more FD locations. The UE may use the one or more TD and/or FD locations to measure the 3D-SSBs.

In certain aspects, the information may include RSRP threshold values, which the UE may use to measure the 3D-SSBs. For instance, when the UE determines that a RSRP associated with an SSB has exceeded a predetermined threshold, the UE may perform initial access based on a 3D-SSB.

In certain aspects, the information may indicate to the UE that some 3D-SSBs may lack a PBCH. Accordingly, when the UE may determine that an SSB may not have the PBCH, the UE may conclude that this SSB is a 3D-SSB.

In certain aspects, the information may indicate to the UE that some 3D-SSBs may have a PSS and a SSS in adjacent symbols. Accordingly, when the UE may determine that an SSB may have the PSS and the SSS in the adjacent symbols, the UE may conclude that this SSB is a 3D-SSB.

As there are large number of 3D-SSBs, a SSB overhead for a holographic MIMO is large. However, in cases, when indexes for the 3D-SSBs may not have to identified by the MIB, and may be indicated by the RMSI, there is a substantial decrease in the overhead.

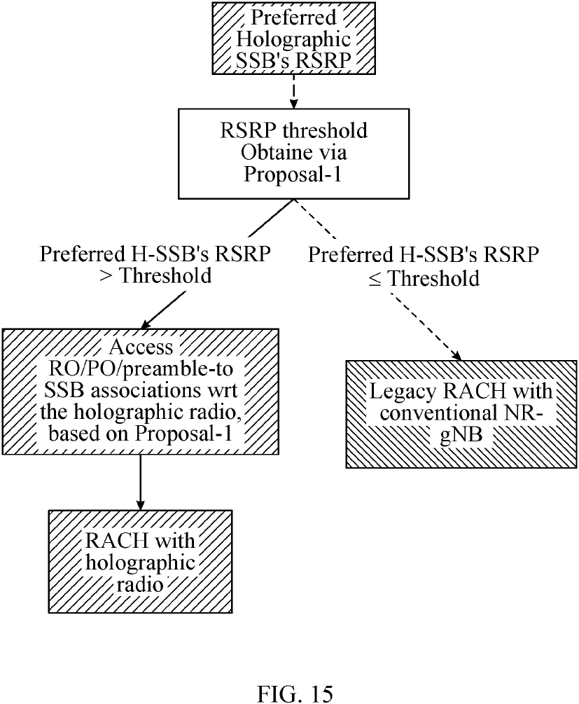

As illustrated in FIG. 15, a UE may be able to optionally directly access a second network entity (for example, a holographic gNB). In some cases, a first network entity (for example, a NR-gNB) may send to the UE signaling indicating a mechanism to access the holographic gNB. The NR-gNB may convey this mechanism via RMSI to the UE.

In certain aspects, the UE may receive the signaling from the NR-gNB indicating the mechanism to access the holographic gNB. The mechanism may inform the UE that to access the holographic gNB, the UE may have to make a preference of some 3D-SSBs. The UE may then determine RSRP of the preferred 3D-SSBs. The UE may then compare the determined RSRP of the preferred 3D-SSBs with a predetermined threshold. If the UE determined RSRP of the 3D-SSBs do not exceed the threshold, the UE may follow a conventional initial access procedure to access the NR-gNB (based on 2D SSBs).

When the determined RSRP of preferred 3D-SSBs may exceed the threshold, the UE may access the holographic gNB. In some cases, the UE may determine an indication of associations of at least one of a random access channel (RACH) occasion (RO), a physical uplink shared channel (PUSCH) occasion (PO), or a preamble associated to the preferred 3D-SSBs, using information (such as the information described in FIG. 14). In some cases, the UE may determine the indication of these associations from RMSI associated with the 2D-SSBs. The UE may then perform a RACH procedure associated with the preferred 3D-SSBs based on the indication of these associations.

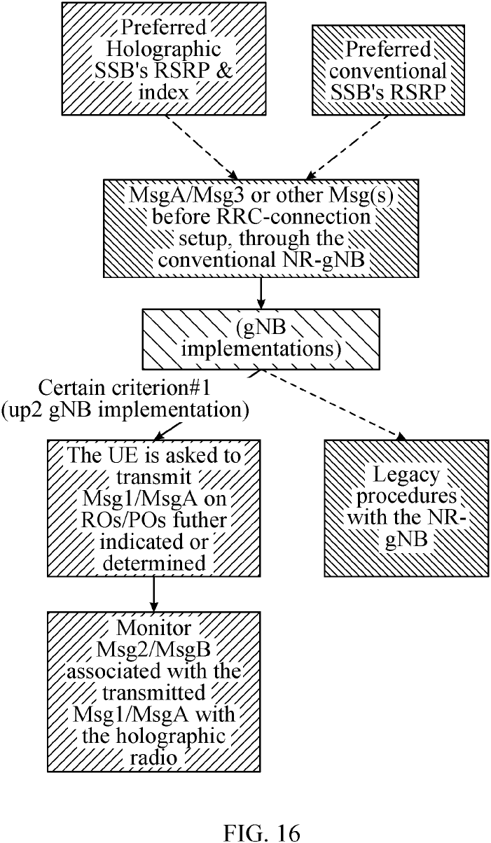

As illustrated in FIG. 16, a UE may be able to optionally indirectly access a second network entity (for example, a holographic gNB). For the indirect access, the UE may measure RSRP for 3D-SSBs based on information (such as the information described in FIG. 14). The UE may also measure RSRP for 2D-SSBs based on the information. The UE may report the RSRP measurements of both 3D-SSBs and 2D-SSBs along with indexes for 3D-SSBs. In some cases, the UE may report these RSRP measurements and indexes via RACH procedures associated with the NR-gNB. In some cases, these RSRP measurements and indexes may be carried by a message (such as MsgA/Msg3), before a setup of RRC connection, through the NR-gNB.

In certain aspects, the UE may further receive a request from the NR-gNB. In one example, the request may be to transmit a RACH preamble on a certain RACH occasion (RO) or PUSCH occasion (PO) associated with a preferred 3D-SSB. In another example, the request may be to transmit a PUSCH on a certain RO or PO associated with the preferred 3D-SSB. The UE may then determine the RACH preamble associated with the preferred 3D-SSB based on RMSI associated with the holographic gNB (for example, RMSI that may be send by the holographic gNB). The UE may also determine the RO or PO associated with the preferred 3D-SSB based on the RMSI associated with the holographic gNB. The UE may then transmit the RACH preamble and/or PUSCH via a message (such as Msg1/MsgA). In some cases, the RACH preamble and the RO or PO associated with the preferred 3D-SSB may be indicated together in the message to the NR-gNB. After transmitting the RACH preamble and/or PUSCH to the NR-gNB, the UE may monitor for a RACH message (such as Msg2/MsgB) from the NR-gNB.

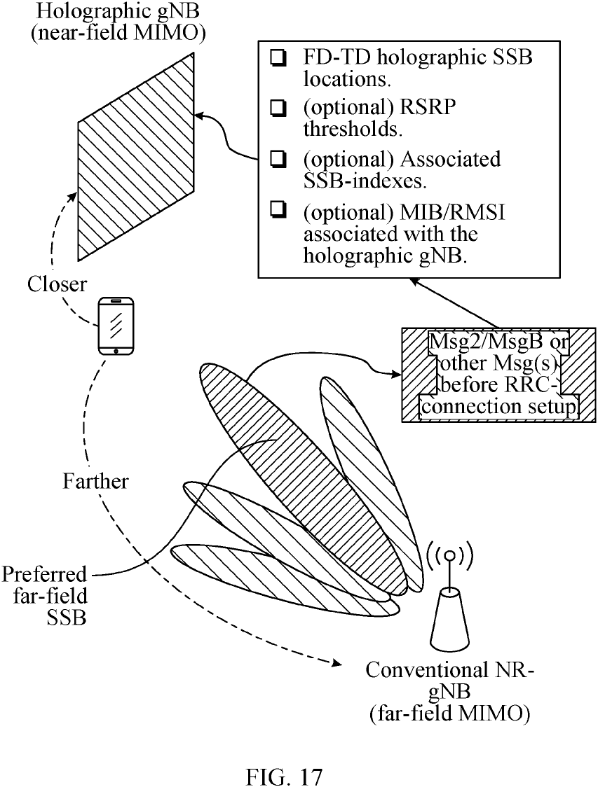

As illustrated in FIG. 17, a UE may receive the holographic SB information via one or more configurations. In some cases, the one or more configurations may be indicated (or scheduled) to the UE by a RACH message (e.g., a Msg2/MsgB or other RACH message). In some cases, the one or more configurations may be indicated (or scheduled) to the UE by any other message from the NR-gNB, prior to a setup of a RRC connection. Further RACH procedures may use previously described mechanisms (e.g., with the UE receiving an indication from the NR-gNB, asking it to transmit preamble/PUSCH on a certain RO/PO associated with the preferred holographic SSB).

### Example UE Capability Report for Holographic MIMO Based Initial Access

As noted above, holographic MIMO antenna arrays may provide a 3D coverage. In some cases, such arrays may be used to generate more beam candidates, relative to 2D coverage provided by NR MIMO antenna.

Although such techniques may enable the UE to have the 3D-SSB based initial access, there are still some limitations associated with having this high number of 3D-SSB candidates. For instance, a holographic MIMO radio may typically consume more SSB overheads in comparison to a NR MIMO radio because of this high number of 3D-SSB candidates. In addition, a UE may have to spend a substantial amount of processing power and time, to randomly detect more hypothesis and/or decode more information, to identify various 3D-SSB indexes (and their associated random access channel occasion (RO), PUSCH occasion (PO), or preamble), which may be used by the UE to determine whether an SSB (within this high number of 3D-SSB candidates) is a 3D-SSB.

To support 3D-SSB based initial access procedures, aspects of the present disclosure provide techniques for the exchange of information regarding the presence of, and UE capability to support, 3D-SSBs. Exchanging capability information in this manner may help avoid the significant resource overhead associated with transmitting 3D-SSBs, as a network may only send 3D-SSBs after receiving confirmation that a UE has the capability to support them.

In one example technique, a first network entity may indicate the UE about a presence of the 3D-SSBs and in response receive a report from the UE indicating its capability to detect and decode different types of the 3D-SSBs. Subsequently, the UE may only receive the 3D-SSBs that the UE may be able to support. Accordingly, the techniques described herein may allow the first network entity to on-demand determine one or more types of the 3D-SSBs that may be transmitted and/or scheduled for the UE, depending on the received report from the UE. This may reduce overall SSB overhead, and also relax and reduce processing complexity of the UE as the UE will not receive and process the 3D-SSBs that the UE may not be capable of supporting.

FIG. 1800 is a flow diagram illustrating example operations 1800 for wireless communication by a UE, in accordance with certain aspects of the present disclosure. The operations 1800 may be performed, for example, by the UE 120a in the wireless communication network 100. The operations 1800 may be implemented as software components that are executed and run on one or more processors (e.g., the controller/processor 280 of FIG. 2). Further, the transmission and reception of signals by the UE in operations 1800 may be enabled, for example, by one or more antennas (e.g., the antennas 252 of FIG. 2). In certain aspects, the transmission and/or reception of signals by the UE may be implemented via a bus interface of one or more processors (e.g., the controller/processor 280) obtaining and/or outputting signals.

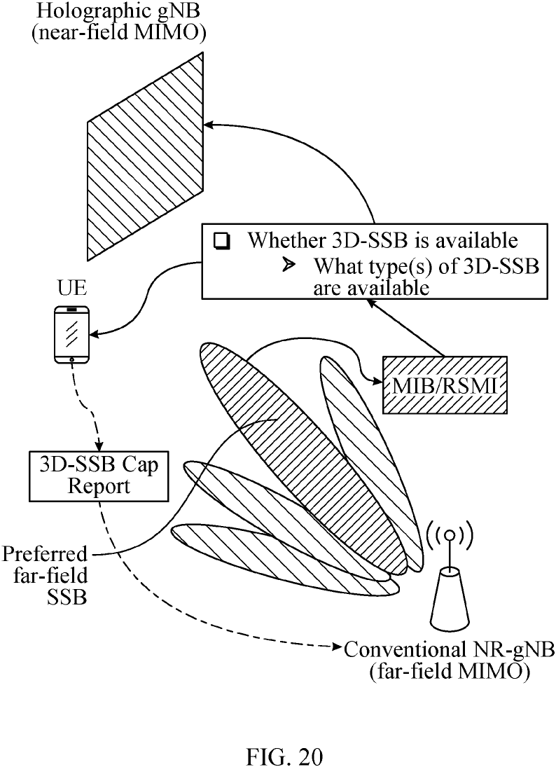

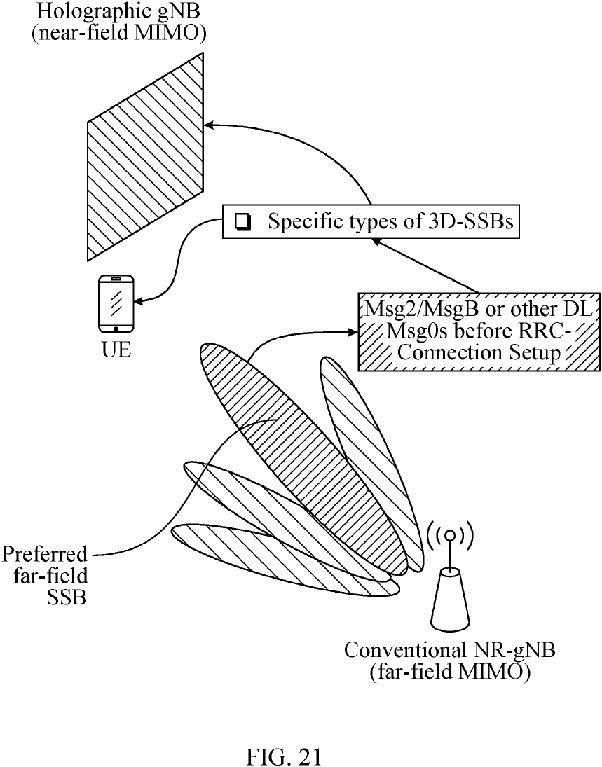

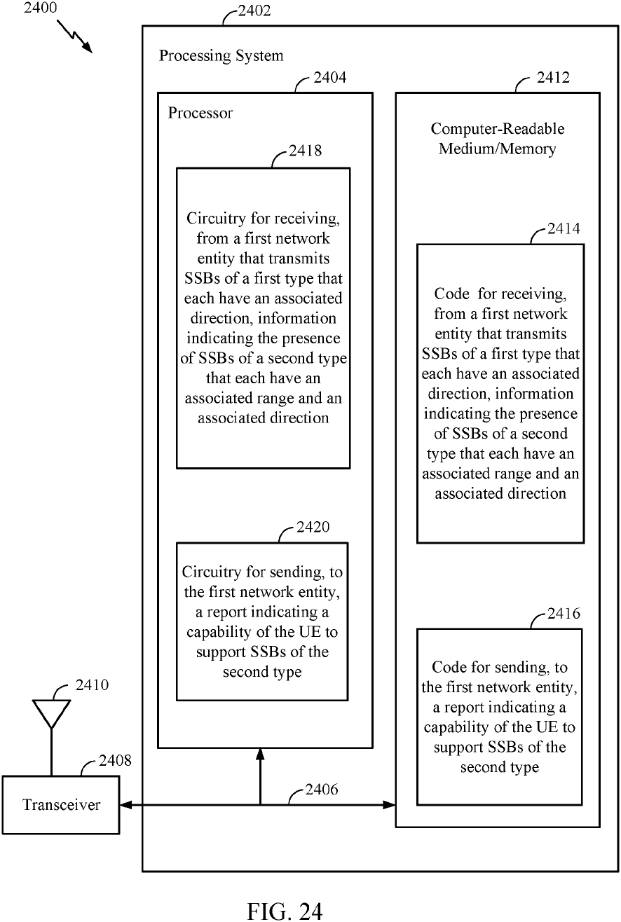

Operations 1800 begin, at 1802, by receiving, from the first network entity that transmits SSBs of a first type that each have an associated direction, information indicating a presence of the SSBs of a second type that each have an associated range and an associated direction. For example, the UE may receive the information using the antenna(s) and receiver/transceiver components of the UE 120a shown in FIG. 2 and/or of the apparatus shown in FIG. 24. In some cases, the information may be received during an initial access procedure. Various mechanisms (e.g., described below with reference to FIGS. 20-21) may be used to signal the information to the UE.

At 1804, the UE sends to the first network entity a report indicating a capability of the UE to support the SSBs of the second type. For example, the UE may send the report using the antenna(s) and transmitter/transceiver components of the UE 120a shown in FIG. 2 and/or of the apparatus shown in FIG. 24. In some cases, the report may be sent during an initial access procedure.

FIG. 19 is a flow diagram illustrating example operations 1900 for wireless communication by a first network entity, in accordance with certain aspects of the present disclosure. The operations 1100 may be performed, for example, by a first network entity (e.g., such as the BS 110a in the wireless communication network 100). The operations 1900 may be implemented as software components that are executed and run on one or more processors (e.g., the controller/processor 240 of FIG. 2). Further, the transmission and reception of signals by the first network entity in operations 1900 may be enabled, for example, by one or more antennas (e.g., the antennas 234 of FIG. 2). In certain aspects, the transmission and/or reception of signals by the first network entity may be implemented via a bus interface of one or more processors (e.g., the controller/processor 240) obtaining and/or outputting signals.

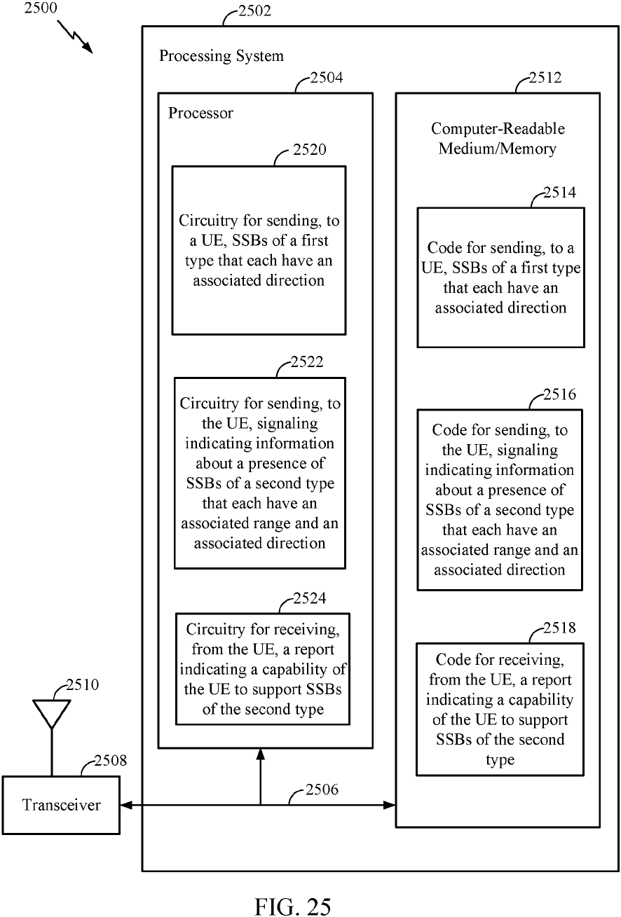

Operations 1900 begin, at 1902, by sending to the UE, SSBs of a first type that each have an associated direction. For example, the first network entity may send the SSBs using antenna(s) and transmitter/transceiver components of the BS 110a shown in FIG. 2 and/or of the apparatus shown in FIG. 25.

At 1904, the first network entity sends to the UE signaling indicating information about a presence of SSBs of a second type that each have an associated range and an associated direction. For example, the network entity may send the information using the antenna(s) and transmitter/transceiver components of the BS 110a shown in FIG. 2 and/or of the apparatus shown in FIG. 25. In some cases, the information may be sent during an initial access procedure.

At 1906, the first network entity receives from the UE a report indicating a capability of the UE to support the SSBs of the second type, in response to the information. For example, the network entity may receive the information using the antenna(s) and receiver/transceiver components of the BS 110a shown in FIG. 2 and/or of the apparatus shown in FIG. 25. In some cases, the report may be received during an initial access procedure.

The operations shown in FIGS. 18 and 19 may be understood with reference to FIGS. 20-21.

As illustrated in FIG. 20, a first network entity (for example, a NR-gNB) and a second network entity (for example, a “holographic gNB” with a holographic MIMO antenna array) may communicate with a UE. The UE may be located within coverage of both first network entity and the second network entity. The NR-gNB may transmit one or more SSBs of a first type (for example, 2D-SSBs). The holographic gNB may transmit one or more SSBs of a second type (for example, 3D-SSBs).

In certain aspects, the NR-gNB may send information to the UE. The information may indicate to the UE whether there is a presence of the 3D-SSBs within the field along with other types of SSBs. In some cases, the information may also indicate to the UE one or more types of the 3D-SSBs available within the field.

In certain aspects, the NR-gNB may send the information to the UE during an initial access procedure. For instance, during the initial access procedure, the NR-gNB may send the 2D-SSBs to the UE. The NR-gNB may convey the information to the UE using one or more channels, which may be associated with the 2D-SSBs.

In certain aspects, the NR-gNB may send a master information block (MIB) to the UE. The MIB may be associated with the 2D-SSBs, which may be sent by the NR-gNB to the UE. The NR-gNB may convey the information to the UE via the MIB. The MIB may also contain other data such as system bandwidth information, etc. The UE may decode the MIB to receive one or more system information blocks (SIBs). The UE may decode the SIBs to obtain the information. The UE may read the information and, in some cases, may determine if there are 3D-SSBs available within the field based on the reading of the information.

In certain aspects, the NR-gNB may send remaining minimum system information (RMSI) to the UE. The RMSI may be associated with the 2D-SSBs, which may be sent by the NR-gNB to the UE. The NR-gNB may send the information to the UE via the RMSI. The UE may decode the RMSI to obtain the information. The UE may read the information. The UE may determine if there are 3D-SSBs available within the field based on the reading of the information.

In certain aspects, the UE may generate a report, in response to processing the received information from the NR-gNB. The report may indicate a capability of the UE to support the 3D-SSBs. In one non-limiting example, the report may indicate whether the UE is able to support detection of the 3D-SSBs among a group of SSBs received by the UE. In another non-limiting example, the report may indicate whether the UE is able to support decoding of the detected 3D-SSBs. In another non-limiting example, the report may indicate whether the UE is able to process multiple types of the 3D-SSBs. In another non-limiting example, the report may indicate a maximum number of the 3D-SSBs that the UE may be able to support. In another non-limiting example, the report may indicate whether the UE is able to support one or more types of multiplexing of the 3D-SSBs. The one or more types of multiplexing of the 3D-SSBs may include frequency division multiplexing (FDM), time division multiplexing (TDM), and/or spatial division multiplexing (SDM). The 3D-SSBs may be transmitted (and identified by the UE) using the FDM, the TDM, and/or the SDM. In another non-limiting example, the report may indicate one or more types of index identification schemes for the 3D-SSBs that the UE may be able to support.

In certain aspects, the UE may send the report to the NR-gNB during the initial access procedure. In one non-limiting example, the report may be carried to the NR-gNB by a random access channel (RACH) procedure message (such as Msg3/MsgA). In another non-limiting example, the report may be carried to the NR-gNB by other type of uplink message, before a setup of radio resource control (RRC) connection, through the NR-gNB.

In certain aspects, the NR-gNB may receive the report. The NR-gNB may process data within the report. As illustrated in FIG. 21, the NR-gNB selects a configuration for the 3D-SSBs based on the processed data within the report. In some cases, the configuration may correspond to 3D-SSBs identification information (i.e., the information that may assist the UE to determine that an SSB is a 3D-SSB based on the capability of the UE).

In certain aspects, the configuration may indicate that some 3D-SSBs may be transmitted using TDM. Such 3D-SSBs may be partitioned into groups of consecutive 3D-SSBs and each 3D-SSB in a group may have a same associated range or a same associated direction. In some cases, some TDMed SSBs may have a same range and a different direction (or a same direction and a different range). The UE may use this information to determine whether an SSB is a TDMed 3D-SSB.

In certain aspects, the configuration may indicate that some 3D-SSBs may be transmitted using FDM. Such 3D-SSBs that may be sent on same frequency resources may also be sent using TDM. Such 3D-SSBs sent on the same frequency resources and also TDMed may be partitioned into groups of consecutive 3D-SSBs, and each 3D-SSBin a group may have a same associated range or a same associated direction. In some cases, some FDMed SSBs may have a same range and a different direction (or a same direction and a different range). The UE may use this information to determine whether an SSB is an FDMed 3D-SSB.

In certain aspects, the configuration may indicate that some of the FDMed 3D-SSBs may lack cell-defining information. The UE may use this information to determine whether an SSB is an FDMed 3D-SSB.

In certain aspects, the configuration may indicate that some 3D-SSBs may be transmitted on same time and frequency resources using SDM. Such 3D-SSBs may include different primary synchronization sequences (PSSs), different secondary synchronization sequences (SSSs), or code division multiplexing (CDM) sequences. In some cases, some SDMed SSBs may have a same range and a different direction (or a same direction and a different range). The UE may use this information to determine whether an SSB is a 3D-SSB.

In certain aspects, the configuration may correspond to SSB indexes. The SSB indexes may be indicated by the MIB, a demodulation reference signal (DMRS) sequence, the RMSI, or a physical downlink control channel (PDCCH) or physical downlink shared channel (PDSCH) determined based on the MIB. The UE may use these indexes to determine whether an SSB is a 3D-SSB.

In certain aspects, the SSB indexes may be indicated by an SSB structure. Such SSB indexes may be indicated via a mapping order of at least one of PSS, SSS, or physical broadcast channel (PBCH) DMRS to resource elements (REs). The UE may use these indexes to determine whether an SSB is a 3D-SSB.

In certain aspects, the SSB indexes may be indicated via an order in which PSS and SSS occur in the SSB structure. The UE may use these indexes to determine whether an SSB is a 3D-SSB.

In In certain aspects, the SSB indexes may be indicated by a dimensional index. The dimensional index may include a direction SSB index identified by a first SSB burst set or a range SSB index identified by a second SSB burst set. The first and the second SSB-burst-sets may be transmitted using the TDM, the FDM, and/or the SDN. The UE may use these indexes to determine whether an SSB is a 3D-SSB.

As illustrated in FIG. 21, the NR-gNB may send the configuration for the 3D-SSBs to the UE. In one non-limiting example, the configuration for the 3D-SSBs may be carried to the UE by a first message (such as Msg3/MsgA). In another non-limiting example, the report may be carried to the UE by a second message (such as an uplink message), before a setup of the RRC connection.

In certain aspects, the UE may receive the first message and/or the second message. The UE may decode these messages to obtain the configuration for the 3D-SSBs. The UE may then monitor the 3D-SSBs in accordance with the received configuration for the 3D-SSBs. The UE may then perform the initial access procedure based on one or more of the monitored 3D-SSBs.

By exchanging information regarding the presence of, and UE capability to support, 3D-SSBs, the resource overhead associated with transmitting 3D-SSBs may be consumed only after receiving confirmation that a UE has the capability to support them.

### Example Wireless Communication Devices

FIG. 22 illustrates a communications device 2200 that may include various components (e.g., corresponding to means-plus-function components) configured to perform operations for the techniques disclosed herein, such as the operations illustrated in FIG. 12. The communications device 2200 includes a processing system 2202 coupled to a transceiver 2208 (e.g., a transmitter and/or a receiver). The transceiver 2208 is configured to transmit and receive signals for the communications device 2200 via an antenna 2210, such as the various signals as described herein. The processing system 2202 is configured to perform processing functions for the communications device 2200, including processing signals received and/or to be transmitted by the communications device 2200.

The processing system 2202 includes a processor 2204 coupled to a computer-readable medium/memory 2212 via a bus 2206. In certain aspects, the computer-readable medium/memory 2212 is configured to store instructions (e.g., computer-executable code) that when executed by the processor 2204, cause the processor 2204 to perform the operations illustrated in FIG. 12, or other operations for performing the various techniques discussed herein for NR-gNB assisted initial access procedure. In certain aspects, computer-readable medium/memory 2212 stores code 2214 for receiving, code 2216 for measuring, and code 2218 for reporting. The code 2214 for receiving may include code for receiving from a first network entity that transmits SSBs of a first type that each have an associated direction, signaling indicating information enabling the UE to measure SSBs of a second type that each have an associated range and an associated direction. The code 2216 for measuring may include code for measuring SSBs of the first and second type based on the information. The code 2218 for reporting may include code for reporting the SSB measurements.

The processor 2204 may include circuitry configured to implement the code stored in the computer-readable medium/memory 2212, such as for performing the operations illustrated in FIG. 12, as well as other operations for performing the various techniques discussed herein for the NR-gNB assisted initial access procedure. For example, the processor 2204 includes circuitry 2220 for receiving, circuitry 2222 for measuring, and circuitry 2224 for reporting. The circuitry 2220 for receiving may include circuitry for receiving from a first network entity that transmits SSBs of a first type that each have an associated direction, signaling indicating information enabling the UE to measure SSBs of a second type that each have an associated range and an associated direction. The circuitry 2222 for measuring may include circuitry for measuring SSBs of the first and second type based on the information. The circuitry 2224 for reporting may include circuitry for reporting the SSB measurements.

FIG. 23 illustrates a communications device 2300 that may include various components (e.g., corresponding to means-plus-function components) configured to perform operations for the techniques disclosed herein, such as the operations illustrated in FIG. 13. The communications device 2300 includes a processing system 2302 coupled to a transceiver 2308 (e.g., a transmitter and/or a receiver). The transceiver 2308 is configured to transmit and receive signals for the communications device 2300 via an antenna 2310, such as the various signals as described herein. The processing system 2302 is configured to perform processing functions for the communications device 2300, including processing signals received and/or to be transmitted by the communications device 2300.

The processing system 2302 includes a processor 2304 coupled to a computer-readable medium/memory 2312 via a bus 2306. In certain aspects, the computer-readable medium/memory 2312 is configured to store instructions (e.g., computer-executable code) that when executed by the processor 2304, cause the processor 2304 to perform the operations illustrated in FIG. 13, or other operations for performing the various techniques discussed herein for NR-gNB assisted initial access procedure. In certain aspects, computer-readable medium/memory 2312 stores code 2314 for transmitting, code 2316 for transmitting, and code 2318 for receiving. The code 2314 for transmitting may include code for transmitting to a UE signaling indicating information enabling the UE to measure SSBs of a second type that each have an associated range and an associated direction. The code 2316 for transmitting may include code for transmitting SSBs of a first type that each have an associate direction. The code 2318 for receiving may include code for receiving from the UE SSB measurements of first and the second type.

The processor 2304 may include circuitry configured to implement the code stored in the computer-readable medium/memory 2312, such as for performing the operations illustrated in FIG. 13, as well as other operations for performing the various techniques discussed herein for the NR-gNB assisted initial access procedure. For example, the processor 2304 includes circuitry 2320 for transmitting, circuitry 2322 for transmitting and circuitry 2324 for receiving. The circuitry 2320 for transmitting may include circuitry for transmitting to a UE signaling indicating information enabling the UE to measure SSBs of a second type that each have an associated range and an associated direction. The circuitry 2322 for transmitting may include circuitry for transmitting SSBs of a first type that each have an associate direction. The circuitry 2324 for receiving may include circuitry for receiving from the UE SSB measurements of first and the second type based on the information.

FIG. 24 illustrates a communications device 2400 that may include various components (e.g., corresponding to means-plus-function components) configured to perform operations for the techniques disclosed herein, such as the operations illustrated in FIG. 18. The communications device 2400 includes a processing system 2402 coupled to a transceiver 2408 (e.g., a transmitter and/or a receiver). The transceiver 2408 is configured to transmit and receive signals for the communications device 2400 via an antenna 2410, such as the various signals as described herein. The processing system 2402 is configured to perform processing functions for the communications device 2400, including processing signals received and/or to be transmitted by the communications device 2400.

The processing system 2402 includes a processor 2404 coupled to a computer-readable medium/memory 2412 via a bus 2406. In certain aspects, the computer-readable medium/memory 2412 is configured to store instructions (e.g., computer-executable code) that when executed by the processor 2404, cause the processor 2404 to perform the operations illustrated in FIG. 18, or other operations for performing the various techniques discussed herein. In certain aspects, computer-readable medium/memory 2412 stores code 2414 for receiving and code 2416 for sending. The code 2414 for receiving may include code for receiving from a first network entity that transmits SSBs of a first type that each have an associated direction, information indicating the presence of SSBs of a second type that each have an associated range and an associated direction. The code 2416 for sending may include code for sending to the first network entity a report indicating a capability of the UE to support SSBs of the second type.

The processor 2404 may include circuitry configured to implement the code stored in the computer-readable medium/memory 2412, such as for performing the operations illustrated in FIG. 18, as well as other operations for performing the various techniques discussed herein. For example, the processor 2404 includes circuitry 2418 for receiving and circuitry 2420 for sending. The circuitry 2418 for receiving may include circuitry for receiving from a first network entity that transmits SSBs of a first type that each have an associated direction, information indicating the presence of SSBs of a second type that each have an associated range and an associated direction. The circuitry 2420 for sending may include circuitry for sending to the first network entity a report indicating a capability of the UE to support SSBs of the second type.

FIG. 25 illustrates a communications device 2500 that may include various components (e.g., corresponding to means-plus-function components) configured to perform operations for the techniques disclosed herein, such as the operations illustrated in FIG. 19. The communications device 2500 includes a processing system 2502 coupled to a transceiver 2508 (e.g., a transmitter and/or a receiver). The transceiver 2508 is configured to transmit and receive signals for the communications device 2500 via an antenna 2510, such as the various signals as described herein. The processing system 2502 is configured to perform processing functions for the communications device 2500, including processing signals received and/or to be transmitted by the communications device 2500.

The processing system 2502 includes a processor 2504 coupled to a computer-readable medium/memory 2512 via a bus 2506. In certain aspects, the computer-readable medium/memory 2512 is configured to store instructions (e.g., computer-executable code) that when executed by the processor 2504, cause the processor 2504 to perform the operations illustrated in FIG. 19, or other operations for performing the various techniques discussed herein. In certain aspects, computer-readable medium/memory 2512 stores code 2514 for sending, code 2516 for sending, and code 2518 for receiving. The code 2514 for sending may include code for sending, to a UE, SSBs of a first type that each have an associated direction. The code 2516 for sending may include code for sending, to the UE, signaling indicating information about a presence of SSBs of a second type that each have an associated range and an associated direction. The code 2518 for receiving may include code for receiving, from the UE, a report indicating a capability of the UE to support SSBs of the second type.

The processor 2504 may include circuitry configured to implement the code stored in the computer-readable medium/memory 2512, such as for performing the operations illustrated in FIG. 19, as well as other operations for performing the various techniques discussed herein. For example, the processor 2504 includes circuitry 2520 for sending, circuitry 2522 for sending, and circuitry 2524 for receiving. The circuitry 2520 for sending may include circuitry for sending, to a UE, SSBs of a first type that each have an associated direction. The circuitry 2522 for sending may include circuitry for sending, to the UE, signaling indicating information about a presence of SSBs of a second type that each have an associated range and an associated direction. The circuitry 2524 for receiving may include circuitry for receiving, from the UE, a report indicating a capability of the UE to support SSBs of the second type.

### Example Aspects

Implementation examples are described in the following numbered aspects.

In a first aspect, a method for wireless communications by a user equipment (UE), comprising: receiving, from a first network entity that transmits synchronization signal blocks (SSBs) of a first type that each have an associated direction, signaling indicating information enabling the UE to measure synchronization signal blocks (SSBs) of a second type that each have an associated range and an associated direction; measuring SSBs of the first and second type based on the information; and reporting the SSB measurements.

In a second aspect, alone or in combination with the first aspect, the information is indicated by the first network entity during an initial access procedure.

In a third aspect, alone or in combination with one or more of the first and second aspects, the information is conveyed via at least one of: a master information block (MIB) associated with an SSB of the first type transmitted by the first network entity; or remaining minimum system information (RMSI) associated with an SSB of the first type transmitted by the first network entity.

In a fourth aspect, alone or in combination with one or more of the first through third aspects, the at least one of MIB or RMSI indicates indexes for the SSBs of the second type.

In a fifth aspect, alone or in combination with one or more of the first through fourth aspects, at least some SSBs of the second type lack a physical broadcast channel (PBCH).

In a sixth aspect, alone or in combination with one or more of the first through fifth aspects, at least some SSBs of the second type have a primary synchronization sequence (PSS) and secondary synchronization sequence (SSS) in adjacent symbols.

In a seventh aspect, alone or in combination with one or more of the first through sixth aspects, the information comprises at least one of frequency domain or time domain locations to measure SSBs of the second type.

In an eighth aspect, alone or in combination with one or more of the first through seventh aspects, the information comprises at least one reference signal received power (RSRP) threshold for SSBs of the second type.

In a ninth aspect, alone or in combination with one or more of the first through eighth aspects, receiving, from the first network entity, signaling indicating a mechanism to access a second network entity that transmits SSBs of the second type.

In a tenth aspect, alone or in combination with one or more of the first through ninth aspects, the mechanism involves: comparing reference signal received power (RSRP) of SSBs of the second type with a threshold; and accessing the second network entity if the RSRP of SSBs of the second type exceeds the threshold.

In an eleventh aspect, alone or in combination with one or more of the first through tenth aspects, the information comprises an indication of associations of at least one of a random access channel (RACH) occasion (RO), physical uplink shared channel (PUSCH) occasion (PO), or preamble associated to SSBs of the second type; and accessing the second network entity comprises performing a RACH procedure based on the associations.

In a twelfth aspect, alone or in combination with one or more of the first through eleventh aspects, accessing the first network entity if the RSRP of SSBs of the second type is less than or equal to the threshold.

In a thirteenth aspect, alone or in combination with one or more of the first through twelfth aspects, the mechanism involves: reporting reference signal received power (RSRP) measurements of SSBs of both the first type and the second type, via a random access channel (RACH) procedure associated with the first network entity.

In a fourteenth aspect, alone or in combination with one or more of the first through thirteenth aspects, receiving a request, from the first network entity, to transmit a RACH preamble or physical uplink shared channel (PUSCH) on a certain RACH occasion (RO) or PUSCH occasion (PO) associated with a preferred SSB of the second type.

In a fifteenth aspect, alone or in combination with one or more of the first to fourteenth aspects, after transmitting the RACH preamble or PUSCH, monitoring for a RACH message from the first network entity.

In a sixteenth aspect, alone or in combination with one or more of the first to fifteenth aspects, the preamble to be transmitted and the RO or PO associated with the preferred SSB of the second type are indicated together.

In a seventeenth aspect, alone or in combination with one or more of the first to sixteenth aspects, the preamble to be transmitted and the RO or PO associated with the preferred SSB of the second type are determined based on remaining minimum system information (RMSI) associated with the second network entity.

In an eighteenth aspect, alone or in combination with one or more of the first to seventeenth aspects, the information is received via one or more configurations indicated by a message received, from the first network entity before radio resource control (RRC) setup.

In a nineteenth aspect, alone or in combination with one or more of the first to eighteenth aspects, the information is received via a random access channel (RACH) message received from the first network entity.

In a twentieth aspect, a method for wireless communications by a first network entity, comprising: transmitting, to a user equipment (UE), signaling indicating information enabling the UE to measure synchronization signal blocks (SSBs) of a second type that each have an associated range and an associated direction; transmitting synchronization signal blocks (SSBs) of a first type that each have an associated direction; and receiving, from the UE, SSB measurements of the first and second type.

In a twenty-first aspect, alone or in combination with the twentieth aspect, the information is indicated by the first network entity during an initial access procedure.

In a twenty-second aspect, alone or in combination with one or more of the twentieth and twenty-first aspects, the information is conveyed via at least one of: a master information block (MIB) associated with an SSB of the first type transmitted by the first network entity; or remaining minimum system information (RMSI) associated with an SSB of the first type transmitted by the first network entity.

In a twenty-third aspect, alone or in combination with one or more of the twentieth through twenty-second aspects, the at least one of MIB or RMSI indicates indexes for the SSBs of the second type.

In a twenty-fourth aspect, alone or in combination with one or more of the twentieth through twenty-third aspects, at least some SSBs of the second type lack a physical broadcast channel (PBCH).

In a twenty-fifth aspect, alone or in combination with one or more of the twentieth through twenty-fourth aspects, at least some SSBs of the second type have a primary synchronization sequence (PSS) and secondary synchronization sequence (SSS) in adjacent symbols.

In a twenty-sixth aspect, alone or in combination with one or more of the twentieth through twenty-fifth aspects, the information comprises at least one of frequency domain or time domain locations to measure SSBs of the second type.

In a twenty-seventh aspect, alone or in combination with one or more of the twentieth through twenty-sixth aspects, the information comprises at least one reference signal received power (RSRP) threshold for SSBs of the second type.

In a twenty-eighth aspect, alone or in combination with one or more of the twentieth through twenty-seventh aspects, transmitting, by the first network entity, to the UE, signaling indicating a mechanism to access a second network entity that transmits SSBs of the second type.

In a twenty-ninth aspect, alone or in combination with one or more of the twentieth through twenty-eighth aspects, the mechanism involves: comparing reference signal received power (RSRP) of SSBs of the second type with a threshold; and accessing the second network entity if the RSRP of SSBs of the second type exceeds the threshold.

In a thirtieth aspect, alone or in combination with one or more of the twentieth through twenty-ninth aspects, the information comprises an indication of associations of at least one of a random access channel (RACH) occasion (RO), physical uplink shared channel (PUSCH) occasion (PO), or preamble associated to SSBs of the second type; and accessing the second network entity comprises performing a RACH procedure based on the associations.

In a thirty-first aspect, alone or in combination with one or more of the twentieth through thirtieth aspects, receiving, by the first network entity, from the UE, a request to access if the RSRP of SSBs of the second type is less than or equal to the threshold.

In a thirty-second aspect, alone or in combination with one or more of the twentieth through thirty-first aspects, the mechanism involves: reporting reference signal received power (RSRP) measurements of SSBs of both the first type and the second type, via a random access channel (RACH) procedure associated with the first network entity.

In a thirty-third aspect, alone or in combination with one or more of the twentieth through thirty-second aspects, sending, by the first network entity, to the UE, a request to transmit a RACH preamble or physical uplink shared channel (PUSCH) on a certain RACH occasion (RO) or PUSCH occasion (PO) associated with a preferred SSB of the second type.

In a thirty-fourth aspect, alone or in combination with one or more of the twentieth through thirty-third aspects, the UE monitors a RACH message from the first network entity after transmitting the RACH preamble or PUSCH.

In a thirty-fifth aspect, alone or in combination with one or more of the twentieth through thirty-fourth aspects, the preamble to be transmitted and the RO or PO associated with the preferred SSB of the second type are indicated together.

In a thirty-sixth aspect, alone or in combination with one or more of the twentieth through thirty-fifth aspects, the preamble to be transmitted and the RO or PO associated with the preferred SSB of the second type are determined based on remaining minimum system information (RMSI) associated with the second network entity.

In a thirty-seventh aspect, alone or in combination with one or more of the twentieth through thirty-sixth aspects, the UE receives the information via one or more configurations indicated by a message received before radio resource control (RRC) setup.

In a thirty-eighth aspect, alone or in combination with one or more of the twentieth through thirty-seventh aspects, the UE receives the information via a random access channel (RACH) message.

In a thirty-ninth aspect, a method for wireless communications by a user equipment (UE), comprising: receiving, from a first network entity that transmits synchronization signal blocks (SSBs) of a first type that each have an associated direction, information indicating a presence of SSBs of a second type that each have an associated range and an associated direction; and sending, to the first network entity, a report indicating a capability of the UE to support SSBs of the second type.

In a fortieth aspect, alone or in combination with the thirty-ninth aspect, the information is received during an initial access procedure.

In a forty-first aspect, alone or in combination with one or more of the thirty-ninth and fortieth aspects, the information is received via at least one of: a master information block (MIB); or remaining minimum system information (RMSI).

In a forty-second aspect, alone or in combination with one or more of the thirty-ninth through forty-first aspects, the information indicates multiple types of SSBs of the second type; and the reports indicates one or more of the types supported by the UE.

In a forty-third aspect, alone or in combination with one or more of the thirty-ninth through forty-second aspects, the report is sent during an initial access procedure.

In a forty-fourth aspect, alone or in combination with one or more of the thirty-ninth through forty-third aspects, the report is sent via a random access channel (RACH) procedure message or other type of uplink message before radio resource control (RRC) setup.

In a forty-fifth aspect, alone or in combination with one or more of the thirty-ninth through forty-fourth aspects, the report indicates at least one of: whether the UE supports detection and decoding of SSBs of the second type; what types of SSBs of the second type the UE supports; or one or more types of multiplexing of SSBs of the second type the UE supports.

In a forty-sixth aspect, alone or in combination with one or more of the thirty-ninth through forty-fifth aspects, the report indicates at least one of: a maximum number of SSBs of the second type the UE supports; or a type of index identification scheme for SSBs of the second type the UE supports.

In a forty-seventh aspect, alone or in combination with one or more of the thirty-ninth through forty-sixth aspects, receiving a configuration for SSBs of the second type; and monitoring for the SSBs of the second type in accordance with the configuration.

In a forty-eighth aspect, alone or in combination with one or more of the thirty-ninth through forty-seventh aspects, the configuration is received via a random access channel (RACH) procedure message or other type of downlink message before radio resource control (RRC) setup.

In a forty-ninth aspect, alone or in combination with one or more of the thirty-ninth through forty-eighth aspects, the configuration for the SSBs of the second type is selected based on the capability of the UE indicated in the report.

In a fiftieth aspect, a method for wireless communications by a first network entity, comprising: sending, to a user equipment (UE), synchronization signal blocks (SSBs) of a first type that each have an associated direction; sending, to the UE, signaling indicating information about a presence of SSBs of a second type that each have an associated range and an associated direction; and receiving, from the UE, a report indicating a capability of the UE to support SSBs of the second type.

In a fifty-first aspect, alone or in combination with the fiftieth aspect, the information is indicated by the first network entity during an initial access procedure.

In a fifty-second aspect, alone or in combination with one or more of the fiftieth and fifty-first aspects, the information is conveyed via at least one of: a master information block (MIB) associated with an SSB of the first type transmitted by the first network entity; or remaining minimum system information (RMSI) associated with an SSB of the first type transmitted by the first network entity.

In a fifty-third aspect, alone or in combination with one or more of the fiftieth through fifty-second aspects, the information indicates multiple types of SSBs of the second type; and the reports indicates one or more of the types supported by the UE.

In a fifty-fourth aspect, alone or in combination with one or more of the fiftieth through fifty-third aspects, the report is received during an initial access procedure.

In a fifty-fifth aspect, alone or in combination with one or more of the fiftieth through fifty-fourth aspects, the report is received via a random access channel (RACH) procedure message or other type of uplink message before radio resource control (RRC) setup.

In a fifty-sixth aspect, alone or in combination with one or more of the fiftieth through fifty-fifth aspects, the report indicates at least one of: whether the UE supports detection and decoding of SSBs of the second type; what types of SSBs of the second type the UE supports; or one or more types of multiplexing of SSBs of the second type the UE supports.

In a fifty-seventh aspect, alone or in combination with one or more of the fiftieth through fifty-sixth aspects, the report indicates at least one of: a maximum number of SSBs of the second type the UE supports; or a type of index identification scheme for SSBs of the second type the UE supports.

In a fifty-eighth aspect, alone or in combination with one or more of the fiftieth through fifty-seventh aspects, sending, to the UE, a configuration for SSBs of the second type, wherein the UE is configured to monitor the SSBs of the second type in accordance with the configuration.

In a fifty-ninth aspect, alone or in combination with one or more of the fiftieth through fifty-eighth aspects, the configuration is conveyed via a random access channel (RACH) procedure message or other type of downlink message before radio resource control (RRC) setup.

In a sixtieth aspect, alone or in combination with one or more of the fiftieth through fifty-ninth aspects, selecting the configuration for the SSBs of the second type based on the capability of the UE indicated in the report.

An apparatus for wireless communication, comprising at least one processor; and a memory coupled to the at least one processor, the memory comprising code executable by the at least one processor to cause the apparatus to perform the method of any of the first through sixtieth aspects.

An apparatus comprising means for performing the method of any of the first through sixtieth aspects.

A computer readable medium storing computer executable code thereon for wireless communications that, when executed by at least one processor, cause an apparatus to perform the method of any of the first through sixtieth aspects.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 12, FIG. 13, FIG. 18 and/or FIG. 19.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications by a user equipment (UE), comprising: at least one processor and a memory configured to:
receive, from a first network entity that transmits synchronization signal blocks (SSBs) of a first type that each have an associated direction, signaling indicating information enabling the UE to measure SSBs of a second type that each have an associated range and an associated direction;
measure the SSBs of the first and second type based on the information; and
report the SSB measurements.

2. The apparatus of claim 1, wherein:
the information is indicated by the first network entity during an initial access procedure;
the information is conveyed via at least one of: a master information block (MIB) associated with an SSB of the first type transmitted by the first network entity or remaining minimum system information (RMSI) associated with an SSB of the first type transmitted by the first network entity; and
the at least one of MIB or RMSI indicates indexes for the SSBs of the second type.

3. The apparatus of claim 1, wherein at least some SSBs of the second type lack a physical broadcast channel (PBCH), and have a primary synchronization sequence (PSS) and secondary synchronization sequence (SSS) in adjacent symbols.

4. The apparatus of claim 1, wherein the information comprises at least one of:
frequency domain or time domain locations to measure SSBs of the second type, or
one reference signal received power (RSRP) threshold for SSBs of the second type.

5. The apparatus of claim 1, wherein the at least one processor is further configured to:
receive, from the first network entity, signaling indicating a mechanism to access a second network entity that transmits SSBs of the second type, wherein the mechanism involves:
compare reference signal received power (RSRP) of SSBs of the second type with a threshold; and
access the second network entity if the RSRP of SSBs of the second type exceeds the threshold.

6. The apparatus of claim 5, wherein:
the information comprises an indication of associations of at least one of a random access channel (RACH) occasion (RO), physical uplink shared channel (PUSCH) occasion (PO), or preamble associated to SSBs of the second type; and
accessing the second network entity comprises performing a RACH procedure based on the associations.

7. The apparatus of claim 5, wherein the at least one processor is further configured to: access the first network entity if the RSRP of SSBs of the second type is less than or equal to the threshold.

8. The apparatus of claim 5, wherein the mechanism involves:
reporting reference signal received power (RSRP) measurements of SSBs of both the first type and the second type, via a random access channel (RACH) procedure associated with the first network entity.

9. The apparatus of claim 8, wherein the at least one processor is further configured to:
receive a request, from the first network entity, to transmit a RACH preamble or physical uplink shared channel (PUSCH) on a certain RACH occasion (RO) or PUSCH occasion (PO) associated with a preferred SSB of the second type; and
after transmitting the RACH preamble or PUSCH, monitor for a RACH message from the first network entity,
wherein the RACH preamble to be transmitted and the RO or PO associated with the preferred SSB of the second type are indicated together, or determined based on remaining minimum system information (RMSI) associated with the second network entity.

10. The apparatus of claim 1, wherein: the information is received via one or more configurations indicated by a message received, from the first network entity before radio resource control (RRC) setup, or is received via a random access channel (RACH) message received from the first network entity.

11. An apparatus for wireless communications by a first network entity, comprising: at least one processor and a memory configured to:
transmit, to a user equipment (UE), signaling indicating information enabling the UE to measure synchronization signal blocks (SSBs) of a second type that each have an associated range and an associated direction;
transmit SSBs of a first type that each have an associated direction; and
receive, from the UE, SSB measurements of the first and second type.

12. The apparatus of claim 11, wherein the information is indicated by the first network entity during an initial access procedure, and wherein the information is conveyed via at least one of:
a master information block (MIB) associated with an SSB of the first type transmitted by the first network entity; or
remaining minimum system information (RMSI) associated with an SSB of the first type transmitted by the first network entity, wherein the at least one of MIB or RMSI indicates indexes for the SSBs of the second type.

13. The apparatus of claim 11, wherein at least some SSBs of the second type lack a physical broadcast channel (PBCH) and have a primary synchronization sequence (PSS) and secondary synchronization sequence (SSS) in adjacent symbols.

14. The apparatus of claim 11, wherein the information comprises at least one of:
frequency domain or time domain locations to measure SSBs of the second type; or
one reference signal received power (RSRP) threshold for SSBs of the second type.

15. The apparatus of claim 11, wherein the at least one processor is further configured to: transmit, by the first network entity, to the UE, signaling indicating a mechanism to access a second network entity that transmits SSBs of the second type.

16. The apparatus of claim 15, wherein the mechanism involves:
comparing reference signal received power (RSRP) of SSBs of the second type with a threshold; and
accessing the second network entity if the RSRP of SSBs of the second type exceeds the threshold, wherein:
the information comprises an indication of associations of at least one of a random access channel (RACH) occasion (RO), physical uplink shared channel (PUSCH) occasion (PO), or preamble associated to SSBs of the second type; and
accessing the second network entity comprises performing a RACH procedure based on the associations.

17. The apparatus of claim 16, wherein the at least one processor is further configured to: receive, by the first network entity, from the UE, a request to access if the RSRP of SSBs of the second type is less than or equal to the threshold.

18. The apparatus of claim 15, wherein the mechanism involves:
reporting reference signal received power (RSRP) measurements of SSBs of both the first type and the second type, via a random access channel (RACH) procedure associated with the first network entity.

19. The apparatus of claim 18, wherein the at least one processor is further configured to:
send, by the first network entity, to the UE, a request to transmit a RACH preamble or physical uplink shared channel (PUSCH) on a certain RACH occasion (RO) or PUSCH occasion (PO) associated with a preferred SSB of the second type, wherein:
the UE monitors a RACH message from the first network entity after transmitting the RACH preamble or PUSCH,
the preamble to be transmitted and the RO or PO associated with the preferred SSB of the second type are indicated together, and
the preamble to be transmitted and the RO or PO associated with the preferred SSB of the second type are determined based on remaining minimum system information (RMSI) associated with the second network entity.

20. An apparatus for wireless communications by a user equipment (UE), comprising: at least one processor and a memory configured to:
receive, from a first network entity that transmits synchronization signal blocks (SSBs) of a first type that each have an associated direction, information indicating a presence of SSBs of a second type that each have an associated range and an associated direction; and
send, to the first network entity, a report indicating a capability of the UE to support SSBs of the second type.

21. The apparatus of claim 20, wherein the information is received during an initial access procedure and indicates multiple types of SSBs of the second type, and wherein the information is received via at least one of:
a master information block (MIB); or
remaining minimum system information (RMSI).

22. The apparatus of claim 20, wherein the report indicates one or more of the types supported by the UE and is sent during an initial access procedure, and wherein the report is sent via a random access channel (RACH) procedure message or other type of uplink message before radio resource control (RRC) setup.

23. The apparatus of claim 20, wherein the report indicates at least one of:
whether the UE supports detection and decoding of SSBs of the second type;
what types of SSBs of the second type the UE supports; or
one or more types of multiplexing of SSBs of the second type the UE supports.

24. The apparatus of claim 20, wherein the report indicates at least one of:
a maximum number of SSBs of the second type the UE supports; or
a type of index identification scheme for SSBs of the second type the UE supports.

25. The apparatus of claim 20, wherein the at least one processor is further configured to:
receive a configuration for SSBs of the second type; and
monitor for the SSBs of the second type in accordance with the configuration, wherein the configuration is received via a random access channel (RACH) procedure message or other type of downlink message before radio resource control (RRC) setup, and wherein the configuration is selected based on the capability of the UE indicated in the report.

26. An apparatus for wireless communications by a first network entity, comprising: at least one processor and a memory configured to:
send, to a user equipment (UE), synchronization signal blocks (SSBs) of a first type that each have an associated direction;
send, to the UE, signaling indicating information about a presence of SSBs of a second type that each have an associated range and an associated direction; and
receive, from the UE, a report indicating a capability of the UE to support SSBs of the second type.

27. The apparatus of claim 26, wherein the information indicates multiple types of SSBs of the second type and is indicated by the first network entity during an initial access procedure, and wherein the information is conveyed via at least one of:
a master information block (MIB) associated with an SSB of the first type transmitted by the first network entity; or
remaining minimum system information (RMSI) associated with an SSB of the first type transmitted by the first network entity.

28. The apparatus of claim 26, wherein the report indicates one or more of the types supported by the UE and is received during an initial access procedure, and wherein the report is received via a random access channel (RACH) procedure message or other type of uplink message before radio resource control (RRC) setup.

29. The apparatus of claim 26, wherein the report indicates at least one of:
whether the UE supports detection and decoding of SSBs of the second type;
what types of SSBs of the second type the UE supports;
one or more types of multiplexing of SSBs of the second type the UE supports;
a maximum number of SSBs of the second type the UE supports; or
a type of index identification scheme for SSBs of the second type the UE supports.

30. The apparatus of claim 26, wherein the at least one processor is further configured to:
select a configuration for the SSBs of the second type based on the capability of the UE indicated in the report; and
send, to the UE, the configuration for SSBs of the second type, wherein the UE is configured to monitor the SSBs of the second type in accordance with the configuration, and wherein the configuration is conveyed via a random access channel (RACH) procedure message or other type of downlink message before radio resource control (RRC) setup.
